(19) United States
(12) Patent Application Publication
(10) Pub. No.: US 2017/0164609 A1
(43) Pub. Date: Jun. 15, 2017

(54) ANTIBACTERIAL SHEET, ANTIBACTERIAL COAT, LAMINATE, AND ANTIBACTERIAL SOLUTION

(71) Applicant: FUJIFILM Corporation, Tokyo (JP)

(72) Inventors: Michihiro SHIBATA, Fujinomiya-shi (JP); Shin OZAWA, Fujinomiya-shi (JP); Tetsuo KAWANO, Fujinomiya-shi (JP); Jou TOMINAGA, Fujinomiya-shi (JP); Naohiro MATSUNAGA, Fujinomiya-shi (JP); Hideo NAGASAKI, Fujinomiya-shi (JP); Naoharu KIYOTO, Fujinomiya-shi (JP); Yusuke HATANAKA, Fujinomiya-shi (JP)

(73) Assignee: FUJIFILM Corporation, Tokyo (JP)

(21) Appl. No.: 15/440,701

(22) Filed: Feb. 23, 2017

Related U.S. Application Data
(63) Continuation of application No. PCT/JP2015/076584, filed on Sep. 17, 2015.

(30) Foreign Application Priority Data
Sep. 22, 2014 (JP) 2014-192246
Apr. 30, 2015 (JP) 2015-093578

(51) Int. Cl. A01N 25/08; A01N 59/00; A01N 25/26; A01N 25/02

(52) U.S. Cl. CPC A01N 25/08; A01N 25/02; A01N 59/00; A01N 25/26

(57) ABSTRACT

An object of the present invention is to provide an antibacterial sheet which is particularly extremely effective for preventing cloudiness or dew condensation and can prevent or inhibit the bacterial multiplication, an antibacterial coat, a laminate, and an antibacterial solution. The antibacterial sheet of the present invention has a support and at least one antibacterial layer disposed on the support, in which the antibacterial layer contains a binder and at least one kind of an antibacterial agent, and a water contact angle of only the binder is equal to or less than 20°.

### CROSS-REFERENCE TO RELATED APPLICATIONS

This application is a Continuation of PCT International Application No. PCT/JP2015/076584 filed on Sep. 17, 2015, which claims priority under 35 U.S.C. §119(a) to Japanese Patent Application No. 2014-192246 filed on Sep. 22, 2014 and Japanese Patent Application No. 2015-093578 filed on Apr. 30, 2015. Each of the above application(s) is hereby expressly incorporated by reference, in its entirety, into the present application.

### BACKGROUND OF THE INVENTION

1. Field of the Invention

The present invention relates to an antibacterial sheet having an antibacterial effect, an antibacterial coat, a laminate, and an antibacterial solution.

2. Description of the Related Art

Contaminants adhere to the surface of medical devices that a plurality of patients or health professionals contact. If the medical devices are left as they are in such a state, bacteria will multiply. In order to inhibit the bacterial multiplication, the surface of the medical devices is appropriately sterilized using a disinfectant such as an aqueous ethanol solution or an aqueous sodium hypochlorite solution.

Incidentally, in recent years, in view of ease of use, the number of medical devices having a touch panel has increased. Although these devices are operated by only health professionals, a biological monitor and the like used in an Intensive Care Unit (ICU) and the like are frequently touched by people, and hence contaminants easily adhere thereto. As a device that many unspecified people contact, a KIOSK terminal (installation type information terminal) having a touch panel such as a returning patient reception unit has become widespread in hospitals.

It is known that antibacterial processing is performed on the surface of devices, such as those located in a hospital environment or a public place, that many unspecified people contact. In a case where different people continuously contact the devices, if the antibacterial effect is weak, bacteria adhere to human beings contacting the devices after a carrier, and hence the intended effect of the antibacterial processing is unlikely to be obtained. If simply the antibacterial effect is sought for, a disinfectant or the like may be caused to be present on the surface at a high concentration, but the strong disinfectant may cause harms such as rash and inflammation to human beings contacting the devices. Therefore, a strong antibacterial effect that is safe for a biological body is required.

The devices placed in a humid environment become cloudy due to dew condensation, and unfortunately, the visibility thereof is hindered. For example, infant incubators combined with a touch panel that have been seen in recent years are in an environment designed to retain heat and moisture. The interior of the incubator is also in an environment designed to retain heat and moisture. Therefore, unfortunately, the inner surface of the transparent incubator hood becomes cloudy or undergoes dew condensation, and this makes it difficult to see the inside of the incubator.

As a solution to the aforementioned problems, the following antibacterial film forming solution is suggested.

JP2008-213206A discloses a transparent article with an antibacterial film including a transparent silver-containing antibacterial film formed on a glass substrate, in which the antibacterial film contains silicon oxide as a main component and silver fine particles and/or silver ions and may further contain a hydrophilic polymer.

JP2014-065182A suggests a bactericidal film including a bactericidal layer which contains a composite material obtained by coating a photocatalyst with an inorganic adsorbent, metal particles, and a resin binder.

### SUMMARY OF THE INVENTION

The inventors of the present invention prepared an antibacterial layer based on the methods described in JP2008-213206A and JP2014-065182A and evaluated the characteristics thereof. As a result, they found that desired effects (the effect of preventing cloudiness or dew condensation or the effect of preventing or inhibiting bacterial multiplication) are not obtained.

The present invention has been made to solve the aforementioned problems, and an object thereof is to provide an antibacterial sheet which is particularly extremely effective for preventing cloudiness or dew condensation and can prevent or inhibit the bacterial multiplication.

Another object of the present invention is to provide an antibacterial coat, a laminate obtained by laminating antibacterial coats, and an antibacterial solution.

In order to achieve the above objects, the inventor of the present invention conducted intensive investigation. As a result, they found that the objects can be achieved by the following constitutions.

(1) An antibacterial sheet comprising a support and at least one antibacterial layer disposed on the support, in which the antibacterial layer contains a binder and an antibacterial agent, and a water contact angle of only the binder is equal to or less than 20°.

(2) The antibacterial sheet according to (1), in which the water contact angle of only the binder is equal to or less than 10°.

(3) The antibacterial sheet according to (1) or (2), in which the binder contains at least one kind of siloxane compound.

(4) The antibacterial sheet according to any one of (1) to (3), in which the antibacterial layer is a layer formed using a coating solution containing a siloxane oligomer represented by Formula (1), which will be described later, and an antibacterial agent.

(5) The antibacterial sheet according to (4), in which the antibacterial layer contains a catalyst accelerating condensation of the siloxane oligomer.

(6) The antibacterial sheet according to any one of (1) to (5), in which the antibacterial layer further contains at least one kind of silica particles.

(7) The antibacterial sheet according to (6), in which the silica particles contain silica particles having a mean particle size of equal to or less than 100 nm.

(8) The antibacterial sheet according to (6) or (7), in which the silica particles contain silica particles having a mean particle size of equal to or less than 20 nm.

(9) The antibacterial sheet according to any one of (1) to (8), in which the antibacterial layer further contains at least one kind of surfactant.

(10) The antibacterial sheet according to (9), in which the surfactantcontains at least one kind of ionic surfactant.

(11) The antibacterial sheet according to (4), in which the coating solution contains an ionic surfactant, and a content of the ionic surfactant is equal to or less than 1.0% by mass with respect to a total mass of the coating solution.

(12) The antibacterial sheet according to any one of (9) to (11), in which the surfactant contains at least one kind of nonionic surfactant.

(13) The antibacterial sheet according to any one of (1) to (12), in which the antibacterial layer further contains an antistatic agent.

(14) The antibacterial sheet according to any one of (1) to (13), in which the antibacterial agent contains silver or silver-supporting ceramic.

(15) The antibacterial sheet according to any one of (1) to (14), in which the antibacterial agent contains silver-supporting glass.

(16) The antibacterial sheet according to any one of (1) to (15), in which a water contact angle of a surface of the antibacterial layer is equal to or less than 20°.

(17) The antibacterial sheet according to any one of (1) to (16), in which the water contact angle of a surface of the antibacterial layer is equal to or less than 10°.

(18) The antibacterial sheet according to any one of (1) to (17), in which an amount of silver ions, measured by an extraction test which will be described later, per unit area of the antibacterial layer is equal to or greater than 15 ng/cm².

(19) The antibacterial sheet according to any one of (1) to (18) that has a haze of equal to or less than 10%.

(20) The antibacterial sheet according to any one of (1) to (19) that has a haze of equal to or less than 3%.

(21) The antibacterial sheet according to any one of (1) to (20) that has a haze of equal to or less than 1%.

(22) The antibacterial sheet according to any one of (1) to (21), in which a root mean square roughness of the surface of the antibacterial layer is equal to or less than 0.1 μm.

(23) The antibacterial sheet according to any one of (1) to (22), in which the root mean square roughness of the surface of the antibacterial layer is equal to or less than 0.05 μm.

(24) The antibacterial sheet according to any one of (1) to (23), in which the root mean square roughness of the surface of the antibacterial layer is equal to or less than 0.01 μm.

(25) The antibacterial sheet according to any one of (1) to (24), in which a surface electrical resistance of the surface of the antibacterial layer is equal to or less than 10¹⁰ Ω/square.

(26) The antibacterial sheet according to any one of (1) to (25), in which the surface electrical resistance of the surface of the antibacterial layer is equal to or less than 10⁹ Ω/square.

(27) The antibacterial sheet according to any one of (1) to (26), in which the surface electrical resistance of the surface of the antibacterial layer is equal to or less than 10⁸ Ω/square.

(28) The antibacterial sheet according to any one of (1) to (27), in which a thickness of the antibacterial layer is equal to or less than 10 μm.

(29) The antibacterial sheet according to any one of (1) to (28), in which the thickness of the antibacterial layer is equal to or less than 3 μm.

(30) The antibacterial sheet according to any one of (1) to (29), in which the thickness of the antibacterial layer is equal to or less than 1 μm.

(31) The antibacterial sheet according to any one of (1) to (30), in which the support consists of any one of polyethylene terephthalate, triacetyl cellulose, and polycarbonate.

(32) An antibacterial coat comprising a binder, an antibacterial agent, a surfactant, and silica particles having a mean particle size of equal to or less than 100 nm, in which the binder is formed using a siloxane oligomer represented by Formula (1) which will be described later.

(33) The antibacterial coat according to (32), in which a water contact angle of materials remaining when the antibacterial agent is excluded from the antibacterial coat is equal to or less than 20°.

(34) The antibacterial coat according to (32) or (33), in which the surfactant contains at least one kind of ionic surfactant.

(35) The antibacterial coat according to any one of (32) to (34), in which the surfactant contains at least one kind of nonionic surfactant.

(36) The antibacterial coat according to any one of (32) to (35), further comprising an antistatic agent.

(37) The antibacterial coat according to any one of (32) to (36), in which the antibacterial agent contains silver or silver-supporting ceramic.

(38) The antibacterial coat according to any one of (32) to (37), in which the antibacterial agent contains silver-supporting glass.

(39) The antibacterial coat according to any one of (32) to (38), in which an amount of silver ions, measured by an extraction test which will be described later, per unit area is equal to or greater than 15 ng/cm².

(40) The antibacterial coat according to any one of (32) to (39) that has a haze of equal to or less than 10%.

(41) The antibacterial coat according to any one of (32) to (40), in which the surface thereof has a root mean square roughness of equal to or less than 0.1 μm.

(42) The antibacterial coat according to any one of (32) to (41), in which the surface thereof has a surface electrical resistance of equal to or less than 10¹⁰ Ω/square.

(43) The antibacterial coat according to any one of (32) to (42) that has a film thickness of equal to or less than 10 μm.

(44) A laminate obtained by laminating at least two layers of the antibacterial coat according to any one of (32) to (43).

(45) An antibacterial solution comprising a siloxane oligomer represented by Formula (1) which will be described later, an antibacterial agent, a surfactant, and silica particles having a mean particle size of equal to or less than 100 nm.

(46) The antibacterial solution according to (45), in which the surfactant contains an ionic surfactant.

(47) The antibacterial solution according to (45) or (46), further comprising water, in which a content of water is equal to or greater than 40% by mass with respect to a total mass of the antibacterial solution.

According to the present invention, it is possible to provide an antibacterial sheet which is particularly extremely effective for preventing cloudiness or dew condensation and can prevent or inhibit bacterial multiplication.

Furthermore, according to the present invention, it is possible to provide an antibacterial coat, a laminate obtained by laminating antibacterial coats, and an antibacterial solution.

### BRIEF DESCRIPTION OF THE DRAWINGS

FIGS. 1A and 1B are cross-sectional views of antibacterial sheets according to embodiments of the present invention.

### DESCRIPTION OF THE PREFERRED EMBODIMENTS

Hereinafter, embodiments of the present invention will be specifically described.

In the present specification, a range of numerical values described using “to” means a range which includes numerical values listed before and after “to” as the lower limit and the upper limit.

The present invention has the aforementioned effects. In addition, those provided by the present invention are excellent in hydrophilicity. Therefore, when a contaminant (such as blood or body fluid) adheres thereto in a medical setting, the contaminant can be removed simply by being wiped off with a damp cloth.

As will be described later, in a case where an antibacterial layer (or an antibacterial coat) contains silica particles and the like which will be described later, a coat surface to which fine powder (dust, pollen, or the like) easily adheres is easily formed, and the adhering contaminant is not easily removed. However, by incorporating a highly antistatic component such as a surfactant into the antibacterial layer, the adhering contaminant is easily removed, and dust protection properties can be improved.

An antibacterial sheet of the present invention has a support and at least one antibacterial layer disposed on the support, in which the antibacterial layer contains a binder and at least one kind of antibacterial agent, and a water contact angle of only the binder is equal to or less than 20°.

Hereinafter, each of the main components contained in the antibacterial layer will be specifically described first, and then the antibacterial sheet will be specifically described.

<Binder>

The antibacterial layer contains a binder. The binder constitutes the antibacterial layer together with the antibacterial agent which will be described later.

In the present invention, a water contact angle of only the binder is equal to or less than 20°. Particularly, in view of satisfying at least one of the effect of further preventing cloudiness or dew condensation and the property of being able to prevent or inhibit bacterial multiplication (hereinafter, simply described as “in view of further improving the effects of the present invention” as well), the water contact angle of only the binder is equal to or less than 10°. The lower limit thereof is not particularly limited, but is equal to or greater than 3° in many cases.

In the present invention, the binder forming the antibacterial layer may consist of a single material such that the water contact angle specified by the present invention is exhibited. However, in the present invention, a material combined with other materials is also regarded as a binder. The materials to be combined refer to the materials constituting the antibacterial layer other than the antibacterial agent, and examples thereof suitably include silica particles, a surfactant, an antistatic agent, a cross-linking agent, a catalyst, an antioxidant, a preservative, a coloring pigment, a dye, a dispersant, and the like. Each of these materials will be specifically described later.

According to the above definition, the water contact angle of only the binder more specifically means a water contact angle of materials remaining when the antibacterial agent is excluded from the materials constituting the antibacterial layer (hereinafter, referred to as a “matrix material” as well). For example, in a case where the antibacterial layer is constituted only with a binder and an antibacterial agent, the water contact angle of only the binder means a water contact angle of only the binder material. Furthermore, in a case where the antibacterial layer is constituted with a composite of a binder, an antibacterial agent, and other materials, the water contact angle of only the binder means a water contact angle of a composite material consisting of the binder and other materials.

That is, the water contact angle of only the binder means a water contact angle of a matrix material when the antibacterial layer is constituted with an antibacterial agent and a matrix material corresponding to other components. For example, in a case where the antibacterial layer is constituted with a binder, a surfactant, an antibacterial agent, and silica particles, the matrix material includes the binder, the surfactant, and the silica particles.

The water contact angle of only the binder has the same definition as a water contact angle of a surface of a layer of only the binder. That is, for example, in a case where the antibacterial layer is constituted only with an antibacterial agent and a binder, a water contact angle of only the binder means a water contact angle of a surface of a layer constituted only with the binder. In a case where the antibacterial layer is constituted only with a binder, an antibacterial agent, and other materials, the “water contact angle of only the binder” means a water contact angle of a surface of a layer constituted with a composite material consisting of the binder and other materials. In other words, when the antibacterial layer is constituted with an antibacterial agent and a matrix material corresponding to components other than the antibacterial agent, the water contact angle of only the binder means a water contact angle of a surface of a layer consisting of the matrix material.

In the present specification, the water contact angle is measured based on a sessile drop method of JIS R 3257:1999. For measuring the water contact angle, LSE-ME1 (software 2win mini) manufactured by NiCK Corporation is used. More specifically, at room temperature (20° C.), 2 μl of droplets of pure water are added dropwise onto a surface of a measurement subject (for example, the antibacterial layer or the layer of the matrix material (for example, the layer of the binder)) which is kept horizontal, and a contact angle at a point in time when 20 seconds has elapsed from the dropping is measured.

Examples of the binder include an organic binder such as a hydrophilic polymer which is particularly preferably a siloxane-containing compound (siloxane compound). The examples also include a monomer or an oligomer forming the above materials.

As the organic binder, for example, it is possible to use organic binders such as polyurethane, a poly(meth)acrylic acid ester, polystyrene, polyester, polyamide, polyimide, and polyurea, and the like. Conceptually, the poly(meth)acrylic acid ester includes both of a polyacrylic acid ester and a polymethacrylic acid ester.

The organic binder preferably contains a hydrophilic group. The type of hydrophilic group is not particularly limited, and examples thereof include a polyoxyalkylene group (for example, a polyoxyethylene group, a polyoxypropylene group, or a polyoxyalkylene group in which an oxyetylene group and an oxypropylene group are bonded to each other in the form of a block copolymer or a random copolymer), an amino group, a carboxyl group, an alkali metal salt of a carboxyl group, a hydroxy group, an alkoxy group, an amide group, a carbamoyl group, a sulfonamide group, a sulfamoyl group, a sulfonic acid group, an alkali metal salt of a sulfonic acid group, and the like. Among these, a polyoxyethylene group is preferable.

As the binder, a siloxane compound (compound having a siloxane bond) can be suitably used.

Particularly, as the binder, a binder (siloxane compound) formed using a siloxane oligomer represented by the following Formula (1) is more preferable. As will be specifically described later, by the hydrolysis and condensation of the siloxane oligomer, a siloxane compound is obtained.

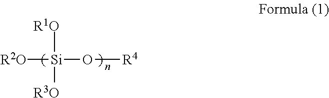

In Formula (1), R¹ to R⁴ each independently represent an organic group having 1 to 6 carbon atoms, and n represents an integer of 2 to 20. The organic group can have a linear structure or a (three-dimensional) branched structure.

In Formula (1), R¹ to R⁴ each independently represent an organic group having 1 to 6 carbon atoms. R¹ to R⁴ may be the same as or different from each other. Furthermore, R¹ to R⁴ may be linear or branched. The organic group represented by R¹ to R⁴ is preferably an alkyl group having 1 to 6 carbon atoms, and examples of the alkyl group represented by R¹ to R⁴ include a methyl group, an ethyl group, a propyl group, an isopropyl group, a n-butyl group, a tert-butyl group, a n-pentyl group, a n-hexyl group, a cyclohexyl group, and the like. In the present invention, if the number of carbon atoms the alkyl group represented by R¹ to R⁴ has is 1 to 6, the hydrolyzability of the siloxane oligomer can be improved. In view of ease of hydrolysis, the alkyl group is more preferably an alkyl group having 1 to 4 carbon atoms, and particularly preferably an alkyl group having 1 or 2 carbon atoms.

In Formula (1), n represents an integer of 2 to 20. If n is within this range, the viscosity of a solution containing a hydrolysate can fall into an appropriate range, and the reactivity of the siloxane oligomer can be controlled within a preferred range. If n is greater than 20, the viscosity of the hydrolysate solution becomes too high, and hence the handling of the solution tends to become difficult. In contrast, if n is 1, the control of the reactivity of alkoxysilane tends to become difficult, and it is difficult to suitably obtain an antibacterial layer having a hydrophilic group after coating. n may be 2 to 20. n is preferably 3 to 15, and more preferably 5 to 10.

By being mixed with a water component, the siloxane oligomer used in the present invention is in a state where at least a portion thereof is hydrolyzed. The hydrolysate of the siloxane oligomer is obtained by reacting the siloxane oligomer with a water component such that an alkoxy group bonded to silicon turns into a hydroxyl group. At the time of hydrolysis, not all the alkoxy groups need to react, but in order for the antibacterial layer to exhibit hydrophilicity, it is preferable the alkoxy groups are hydrolyzed as many as possible. The minimum amount of the water component required at the time of hydrolysis is the same as the molar amount of the alkoxy group of the siloxane oligomer. In order to make the reaction smoothly proceed, it is preferable that a large excess of water is present.

The hydrolysis reaction may proceed at room temperature. However, in order to accelerate the reaction, heating may be performed. It is preferable that the reaction time is long, because then the reaction proceeds better. Furthermore, if the reaction is performed in the presence of a catalyst which will be described later, a hydrolysate can be obtained within about half a day.

The hydrolysis reaction is a reversible reaction. When water is removed from the system, the hydrolysate of the siloxane oligomer starts to be condensed between hydroxyl groups. Accordingly, in a case where an aqueous solution of the hydrolysate is obtained by reacting. a large excess of water with the siloxane oligomer, it is preferable to use the aqueous solution as it is as a raw material of the antibacterial layer without forcedly isolate the hydrolysate from the aqueous solution.

As will be specifically described later, the antibacterial layer can be manufactured using a coating solution containing predetermined components, and it is preferable that the coating solution contains a water component as a main solvent. If the water component is used as a solvent, a load imposed on the health of an operator at the time of handling or an environmental load is reduced, and it is possible to prevent the hydrolysate of the siloxane oligomer from being condensed in the solution during storage.

The water component used in the present invention contains water as a main component, and the content of water is preferably equal to or greater than 10% by mass, more preferably equal to or greater than 30% by mass, and even more preferably equal to or greater than 40% by mass. Furthermore, the water component may contain an organic solvent or a compound in addition to water. For example, the water component may have a hydrophilic organic solvent. If the water component contains a hydrophilic organic solvent, it is possible to obtain an effect of making it possible to perform uniform coating due to the reduction in surface tension and an effect of facilitating drying due to the increase in a proportion of a low-boiling point solvent.

The hydrophilic organic solvent is not particularly limited, and examples thereof include methanol, ethanol, isopropanol, butanol, acetone, ethylene glycol, ethyl cellosolve, and the like. Considering the environmental load or the load imposed on the health of an operator, alcohols are preferable, and ethanol or isopropanol is more preferable.

<Antibacterial Agent>

The antibacterial layer contains at least one kind of antibacterial agent. Particularly, in view of further improving antibacterial properties, it is preferable that the antibacterial layer contains at least one kind of silver-containing antibacterial agent.

The type of antibacterial agent contained in the antibacterial layer is not particularly limited, and known antibacterial agents can be used. As the antibacterial agent, those exerting a bactericidal effect on pathogenic bacteria represented by Staphylococcus aureus and E. coli are suitably used.

The silver-containing antibacterial agent (hereinafter, referred to as a silver-based antibacterial agent as well) should contain silver (silver atoms), and the type thereof is not particularly limited. Furthermore, the form of silver is not particularly limited, and for example, the silver is contained in the antibacterial agent in the form of metallic silver, a silver ion, a silver salt (including a silver complex), and the like. Examples of the silver-based antibacterial agent preferably include inorganic antibacterial agent containing silver particles, which slowly release silver ions, or silver, such as those obtained by causing silver or silver ions to be supported on a support. In the present specification, a silver complex is included in the scope of a silver salt.

Examples of the silver salt include silver acetate, silver acetylacetonate, silver azide, silver acetylide, silver arsenate, silver benzoate, silver hydrogen fluoride, silver bromate, silver bromide, silver carbonate, silver chloride, silver chlorate, silver chromate, silver citrate, silver cyanate, silver cyanide, silver (cis,cis-1,5-cyclooctadiene)-1,1,1,5,5,5-hexafluoroacetylacetonate, silver diethyldithiocarbamate, silver (I) fluoride, silver (II) fluoride, silver 7,7-dimethyl-1,1,1,2,2,3,3-heptafluoro-4,6-octanedioate, silver hexafluoroantimonate, silver hexafluoroarsenate, silver hexafluorophosphate, silver iodate, silver iodide, silver isothiocyanate, potassium silver cyanide, silver lactate, silver molybdate, silver nitrate, silver nitrite, silver (I) oxide, silver (II) oxide, silver oxalate, silver perchlorate, silver perfluorobutyrate, silver perfluoropropionate, silver permanganate, silver perrhenate, silver phosphate, silver picrate monohydrate, silver propionate, silver selenate, silver selenide, silver selenite, silver sulfadiazine, silver sulfate, silver sulfide, silver sulfite, silver telluride, silver tetrafluoroborate, silver tetraiodomercurate, silver tetratungstate, silver thiocyanate, silver p-toluenesulfonate, silver trifluoromethanesulfonate, silver trifluoroacetate, silver vanadate, and the like.

An example of the silver complex include a histidine-silver complex, a methionine-silver complex, a cysteine-silver complex, an aspartic acid-silver complex, a pyrrolidone carboxylic acid-silver complex, an oxotetrahydrofuran carboxylic acid-silver complex, an imidazole-silver complex, or the like.

Examples of the silver-based antibacterial agent include an organic silver-based antibacterial agent such as the aforementioned silver salt (silver complex) and an inorganic silver-based antibacterial agent containing a support which will be described later. The type of silver-based antibacterial agent is not particularly limited.

Among the silver-based antibacterial agents, in view of further improving light fastness of the antibacterial layer and/or further improving antibacterial properties, a silver-supporting support including a support and silver supported on the support is preferable.

The type of support is not particularly limited, and examples thereof include a silicate-based support, a phosphate-based support, an oxide (for example, glass), potassium titanate, and an amino acid.

Examples of the support include a zeolite-based antibacterial agent support, a calcium silicate-based antibacterial agent support, a zirconium phosphate-based antibacterial agent support, a calcium phosphate-based antibacterial agent support, a zinc oxide-based antibacterial agent support, a soluble glass-based antibacterial agent support, a silica gel-based antibacterial agent support, an activated carbon-based antibacterial agent support, a titanium oxide-based antibacterial agent support, a titania-based antibacterial agent support, an organic metal-based antibacterial agent support, an ion exchanger ceramic-based antibacterial agent support, a layered phosphate-quaternary ammonium salt-based antibacterial agent support, an antibacterial stainless steel support, and the like, but the support is not limited to these.

Specific examples of the support include calcium zinc phosphate, calcium phosphate, zirconium phosphate, aluminum phosphate, calcium silicate, activated carbon, activated alumina, silica gel, zeolite, hydroxyapatite, zirconium phosphate, titanium phosphate, potassium titanate, hydrous bismuth oxide, hydrous zirconium oxide, hydrotalcite, and the like. Examples of zeolite include natural zeolite such as chabazite, mordenite, erionite, and clinoptilolite, and synthetic zeolite such as type A zeolite, type X zeolite, and type Y zeolite.

As the support, in view of further improving the effects of the present invention, so-called ceramics are preferable.

The content of silver in the silver-based antibacterial agent is not particularly limited. For example, in a case of the aforementioned silver-supporting support, the content of silver is preferably 0.1 to 10 wt % and more preferably 0.3 to 5 wt % with respect to a total mass of the silver-supporting support.

Among the above antibacterial agents, silver such as silver particles or ceramic supporting silver (silver-supporting ceramic) is preferable because these have a strong antibacterial effect. More specifically, examples thereof include silver particles, silver zeolite in which silver is supported on zeolite as a silicate-based support, and an antibacterial agent in which silver is supported on silica gel, and an antibacterial agent in which silver is supported on glass (silver-supporting glass).

The mean particle size of the silver particles is preferably 1 nm to 100 nm, and more preferably 1 nm to 20 nm. The smaller the particle size of the silver particles, the greater the surface area/volume ratio, and as a result, antibacterial properties can be exhibited with a smaller amount of silver particles.

Examples of particularly preferred commercially available silver zeolite-based antibacterial agents include “ZEOMIC” from Sinanen Zeomic Co., Ltd., “SILWELL” from FUJI SILYSIA CHEMICAL LTD., “BACTENON” from JAPAN ELECTRONIC MATERIALS CORPORATION, and the like. In addition, “NOVARON” from TOAGOSEI CO., LTD. in which silver is supported on inorganic ion exchanger ceramics, “ATOMY BALL” from Shokubai Kasei Kogyo Co., and “SAN-AI BACK P” as a triazine-based antibacterial agent are also preferable. As silver particles, “NANOSILVER” from Japan Ion Corporation. can be selected. Furthermore, it is also possible to select “BACTEKILLER” or “BACTELITE” from Fuji Chemical Industries, Ltd. consisting of silver-supporting ceramic particles (silver ceramic particles) obtained by chemically bonding silver to ceramics.

In the present invention, in addition to the silver-containing antibacterial agent, other known antibacterial agents may be used, and these may be used in combination with the silver-containing antibacterial agent. Examples of other known antibacterial agents include an inorganic antibacterial agent not containing silver or an organic antibacterial agent (preferably a water-soluble organic antibacterial agent).

Examples of the organic antibacterial agent include a phenol ether derivative, an imidazole derivative, a sulfone derivative, a N-haloalkylthio compound, an anilide derivative, a pyrrole derivative, a quaternary ammonium salt, a pyridine-based compound, a triazine-based compound, a benzisothiazoline-based compound, an isothiazoline-based compound, and the like.

More specifically, examples of the organic antibacterial agent include 1,2-benzisothiazolin-3-one, N-fluorodichloromethylthio-phthalimide, 2,3,5,6-tetrachloroisophthalonitrile, N-trichloromethylthio-4-cyclohexene-1,2-dicarboximide, copper 8-quinolinate, bis(tributyltin)oxide, 2-(4-thiazolyl)benzimidazole <hereinafter, described as TBZ>, methyl 2-benzimidazole carbamate <hereinafter, described as BCM>, 10,10′-oxybisphenoxarsine <hereinafter, described as OBPA>, 2,3,5,6-tetrachloro-4-(methylsulfone)pyridine, zinc bis(2-pyridylthio-1-oxide) <hereinafter, described as ZPT>, N,N-dimethyl-N′-(fluorodichloromethylthio)-N′-phenylsulfonamide<dichlofluanide>, poly-(hexamethylenebiguanide)hydrochloride, dithio-2-2′-bis(benzmethylamide), 2-methyl-4,5-trimethylene-4-isothiazolin-3-one, 2-bromo-2-nitro-1,3-propanediol, hexahydro-1,3-tris-(2-hydroxyethyl)-S-triazine, p-chloro-m-xylenol, and the like, but the organic antibacterial agent is not limited to these.

These organic antibacterial agents can be appropriately selected and used in consideration of hydrophilicity, water resistance, sublimation properties, safety, and the like. Among these organic antibacterial agents, in view of hydrophilicity, antibacterial effects, and costs, 2-bromo-2-nitro-1,3-propanediol, TBZ, BCM, OBPA, or ZPT is preferable.

The organic antibacterial agent also includes a natural antibacterial agent. The natural antibacterial agent includes chitosan which is basic polysaccharide obtained by hydrolyzing chitin contained in crustacean such as crab or shrimp.

Examples of the inorganic antibacterial agent include mercury, copper, zinc, iron, lead, bismuth, and the like listed in descending order of the strength of the antibacterial effect. Examples of the inorganic antibacterial agent also include those obtained by causing a metal such as copper, zinc, or nickel or metal ions to be supported on a support. As the support, those described above can be used.

Among the above antibacterial agents, metal particles (particularly, copper particles are preferable) or organic antibacterial agents are preferable because these have a strong antibacterial effect. As the organic antibacterial agent, 2-bromo-2-nitro-1,3-propanediol, TPN, TBZ, BCM, OBPA, or ZPT is preferable.

As the most preferred aspect of the inorganic antibacterial agent used in combination with the silver-containing inorganic antibacterial agent, copper particles, which slowly release copper ions, and copper ceramic particles are preferable.

<Other Optional Components>

As will be specifically described later, the antibacterial layer contains the aforementioned binder and antibacterial agent, and may contain other components.

Hereinafter, the optional components will be specifically described.

(Antistatic Agent)

The antibacterial layer may contain an antistatic agent.

The type of antistatic agent is not particularly limited, and know materials can be used. Examples thereof preferably include metal oxide particles.

The metal oxide fine particles used as an antistatic agent are not particularly limited, and examples thereof include tin oxide fine particles, antimony-doped tin oxide fin particles, tin-doped indium oxide fine particles, zinc oxide fine particles, and the like. Furthermore, metal oxide fine particles which have different sizes or shapes or consist of different materials may be used by being mixed together. The oxide particles have a great refractive index, and the greater the particle size of the oxide particles, the greater the loss resulting from excessive scattering transmission light. Therefore, a primary particle size of the oxide particles is preferably equal to or less than 100 nm, more preferably equal to or less than 50 nm, and even more preferably equal to or less than 30 nm. The lower limit thereof is not particularly limited, but is equal to or greater than 1 nm in many cases.

The shape of the particles is not particularly limited, and the particles may have a spherical shape, a plate shape, or a needle shape.

The primary particle size of the metal oxide fine particles may be determined from a picture which is obtained by observing the dispersed particles by using a transmission electron microscope. A projected area of the particles is determined, and an equivalent circle diameter is determined therefrom and taken as a mean particle size (mean primary particle size). In the present specification, a primary particle size (mean particle size) can be calculated from an equivalent circle diameter determined by measuring a projected area for 300 or more particles.

In a case where the shape of the metal oxide fine particles is not spherical, the primary particle size thereof may be determined using, for example, a dynamic light scattering method.

(Silica Fine Particles)

The antibacterial layer may contain silica particles.

The silica particles function to improve the physical resistance of the antibacterial layer and to exhibit hydrophilicity. That is, the silica particles play a role as a hard filler and make a contribution to further improve the hydrophilicity by the hydroxyl group on the surface thereof.

The shape of the silica particles which can be used in the present invention is not particularly limited, and for example, the silica particles have a spherical shape, a plate shape, a needle shape, a necklace shape, or the like. Two or more kinds of different silica particles may be used. Furthermore, the silica particles may have a structure consisting of a shell formed of silica and a core containing air or an organic resin. It is preferable that a surface treatment is performed on the surfaces of the silica particles such that the particles are stably dispersed.

If the particle size of the silica particles added is greater than a certain extent, the transmission light is scattered in some cases. Therefore, the mean particle size (primary particle size) of the silica fine particles is preferably equal to or less than 100 nm, more preferably equal to or less than 50 nm, even more preferably equal to or less than 30 nm, and particularly preferably equal to or less than 20 nm. The lower limit thereof is not particularly limited, but is equal to or greater than 1 nm in many cases.

Furthermore, silica particles having different sizes or shapes may be used by being mixed together.

The mean particle size (primary particle size) of the silica fine particles can be measured by the same method as used for measuring the primary particle size of the aforementioned metal oxide fine particles.

(Component exhibiting surface activity (surface-active component))

The antibacterial layer may contain a component exhibiting surface activity.

In the present invention, the component exhibiting surface activity may be a surface-active component derived from an antistatic agent. In a case where the antistatic agent does not have a surface-active component, it is preferable that the antibacterial layer contains a surfactant. That is, in the present invention, the component exhibiting surface activity contains at least one of the surface-active component derived from an antistatic agent and the surface-active component derived from a surfactant.

If the antibacterial layer contains such a surface-active component, the coating properties of the coating solution used for forming the antibacterial layer can be improved. Furthermore, due to the presence of the surface-active component, the surface tension of the coating solution is reduced, and hence coating can be more uniformly performed.

As described above, if the antibacterial layer contains a surfactant, the adhering contaminant can be easily removed, and the dust protection properties can be improved. Particularly, in a case where a nonionic surfactant and an ionic surfactant (particularly, an anionic surfactant) are used in combination, the dust protection properties are further improved.

For the aforementioned purpose, all of the nonionic and ionic (anionic, cationic, and amphoteric) surfactants can be suitably used. In a case where an ionic surfactant is used as the aforementioned antistatic agent, the ionic surfactant added as the antistatic agent may function to improve wettability.

Here, if an excess of ionic surfactant is added, the mass of electrolytes in the system increases, and hence the silica fine particles are aggregated. Therefore, in a case where an ionic surfactant is used as the antistatic agent, it is preferable that the antibacterial layer additionally contains a component exhibiting nonionic surface activity. The component exhibiting nonionic surface activity does not need to be used in combination with the ionic surfactant, and the component exhibiting nonionic surface activity may be used singly as a surface-active component.

Examples of the nonionic surfactant include polyalkylene glycol monoalkyl ethers, polyalkylene glycol monoalkyl esters, polyalkylene glycol monoalkyl ester.monoalkyl ethers, and the like. More specifically, examples thereof include polyethylene glycol monolauryl ether, polyethylene glycol monostearyl ether, polyethylene glycol monocetyl ether, polyethylene glycol monolauryl ester, polyethylene glycol monostearyl ester, and the like.

Examples of the ionic surfactant include an anionic surfactant such as alkyl sulfate, alkylbenzene sulfonate, or alkyl phosphate, a cationic surfactant such as an alkyltrimethyl ammonium salt or a dialkyldimethyl ammonium salt, and an amphoteric surfactant such as alkylcarboxybetaine.

(Catalyst)

The antibacterial layer may contain a catalyst.

Examples of the catalyst preferably include the aforementioned catalyst that accelerates the condensation of the siloxane oligomer. If such a catalyst is used, an antibacterial layer having excellent durability can be formed. In the present invention, the coating solution for forming the antibacterial layer is dried after coating such that moisture is removed, and in this way, (at least a portion of) hydroxyl groups contained in the hydrolysate of the siloxane oligomer are condensed with and bonded to each other, whereby a stable coating film can be foimed. At this time, if a catalyst that accelerates the condensation of the siloxane oligomer is present, the antibacterial layer can be more rapidly formed.

The catalyst accelerating the condensation of the siloxane oligomer that can be used in the present invention is not particularly limited, and examples thereof include an acid catalyst, an alkali catalyst, an organic metal catalyst, and the like. Examples of the acid catalyst include nitric acid, hydrochloric acid, sulfuric acid, acetic acid, chloroacetic acid, formic acid, oxalic acid, toluenesulfonic acid, and the like. Examples of the alkali catalyst include sodium hydroxide, potassium hydroxide, tetramethylammonium hydroxide, and the like. Examples of the organic metal catalyst include an aluminum chelating compound such as aluminum bis(ethylacetoacetate)mono(acetylacetonate), aluminum tris(acetylacetonate), or aluminum ethylacetoacetate diisopropylate, a zirconium chelating compound such as zirconium tetrakis(acetylacetonate) or zirconium bis(butoxy)bis(acetylacetonate), a titanium chelating compound such as titanium tetrakis(acetylacetoate) or titanium bis(butoxy)bis(acetylacetonate), an organic tin compound such as dibutyltin diacetate, dibutyltin dilaurate, or dibutyltin dioctoate, and the like. The type of the aforementioned catalyst is not particularly limited. Among the above, an organic metal catalyst is preferable, and an aluminum chelating compound or a zirconium chelating compound is particularly preferable.

The catalyst accelerating the condensation of the siloxane oligomer is also useful for the aforementioned hydrolysis of the siloxane oligomer. The hydrolysis reaction of an alkoxy group bonded to silicon of the siloxane oligomer is in an equilibrium relationship with the condensation reaction. If there is a large amount of water in the system, the reaction shifts to the hydrolysis, and if there is a small amount of water, the reaction shifts to the condensation. The catalyst accelerating the condensation reaction of an alkoxy group causes the reaction to shift to both of the hydrolysis and condensation. Therefore, in a state where there is a large amount of water in the system, the hydrolysis reaction can be accelerated. Due to the presence of the catalyst, it is possible to more reliably perform the hydrolysis of the siloxane oligomer under milder conditions.

At this time, if the catalyst used for the hydrolysis reaction of the siloxane oligomer is kept as it is in the system and used as a component of the coating solution such that the catalyst is used as it is as a catalyst for the condensation of the siloxane oligomer, the efficiency become excellent.

(Dispersant)

The antibacterial layer may contain a dispersant.

As the dispersant, a nonionic or anionic dispersant is preferably used.

Examples of the nonionic dispersant include polyoxyethylene alkyl ether such as polyoxyethylene lauryl ether, polyoxyethylene stearyl ether, or polyoxyethylene oleyl ether, polyoxyethylene alkyl phenyl ether such as polyoxyethylene octyl phenyl ether or polyoxyethylene nonyl phenyl ether, polyoxyethylene alkyl ester such as polyethylene glycol dilaurate or polyethylene glycol distearate, polyoxyethylene sorbitan fatty acid ester, polyoxyethylene alkyl amine, polyoxyethylene alkyl amide, an acetylene glycol-based dispersant, and the like.

Examples of the anionic dispersant preferably include a polymer amine-based dispersant.

The polymer amine-based dispersant is a linear polymer having an affinity portion consisting of a basic affinity group on at least one terminal (including both terminals) of a main chain due to a block or graft structure. The basic affinity group is a heterocyclic group having a tertiary amino group, a quaternary ammonium group, or a basic nitrogen atom, and examples of the linear polymer include at least one kind of polymer among polyacrylate, polyurethane, polyester, and a modification substance of these. Examples of the heterocyclic group include a pyrrole group, an imidazole group, a pyridinyl group, a pyrimidinyl group, and the like.

The number of the basic affinity groups present in a single molecule is preferably 2 to 3,000. If the number is less than 2, color unevenness may occur, and if the number is greater than 3,000, the viscosity may become too high, and hence the handling may become difficult. The number is more preferably 5 to 1,500.

The polymer amine-based dispersant preferably has a number-average molecular weight of 1,000 to 1,000,000. If the number-average molecular weight is less than 1,000, color unevenness may occur, and if it is greater than 1,000,000, the viscosity may become too high, and hence the handling may become difficult. The number-average molecular weight is more preferably 2,000 to 500,000.

For example, as the amine-based dispersant, it is possible to use “DISPERBYK-160”, “DISPERBYK-161”, “DISPERBYK-162”, “DISPERBYK-180”, “DISPERBYK-181”, “DISPERBYK-182” (all manufactured by BYK-Chemie GmbH.), “SOLSPERSE 20000” (manufactured by ZENECA INC), “EFKA-4550” and “EFKA-4580” (all manufactured by EFKA Additives).

As the nonionic dispersant, “DISPERBYK-190”, “DISPERBYK-191” (all manufactured by BYK-Chemie GmbH), and the like can be used.

In addition, examples of the dispersant include, but is not limited to, a polymer dispersant such as EFKA-46, EFKA-47, EFKA-47EA, EFKA POLYMER-100, EFKA POLYMER-400, EFKA POLYMER-401, EFKA POLYMER-450 (all manufactured by EFKA Additives), DISPERSE-AYD 6, DISPERSE-AYD 8, DISPERSE-AYD 15, or DISPERSE-AYD 9100 (manufactured by SAN NOPCO LIMITED), various SOLSPERSE dispersants (manufactured by ZENECA Inc.) such as SOLSPERSE 3000, 5000, 9000, 12000, 13240, 13940, 17000, 24000, 26000, and 28000, DISPERBYK-183, DISPERBYK-184, DISPERBYK-185, DISPERBYK-192, DISPERBYK-193, DISPERBYK-194, DISPERBYK-2010, DISPERBYK-2015, DISPERBYK-2090, DISPERBYK-2091, DISPERBYK-2096, and the like (all manufactured by BYK-Chemie Japan KK.), EMULGEN 104P, EMULGEN 105, EMULGEN 106, EMULGEN 108, EMULGEN 109P, EMULGEN 120, EMULGEN 123P, EMULGEN 147, EMULGEN 150, EMULGEN 210P, EMULGEN 220, EMULGEN 306P, EMULGEN 320P, EMULGEN 350, EMULGEN 404, EMULGEN 408, EMULGEN 409PV, EMULGEN 420, EMULGEN 430, EMULGEN 705, EMULGEN 707, EMULGEN 709, and the like (all manufactured by Kao Corporation).

(Other Additives)

The antibacterial layer of the present invention may appropriate contain additives such as a cross-linking agent, a curing accelerator, an antioxidant, a preservative, a coloring pigment, and a dye, in addition to the aforementioned components. Meanwhile, the coating solution, which will be described later, used for forming the antibacterial layer does not need to be irradiated with light or treated at a high temperature at the time of forming a film after coating. Therefore, a photopolymerization initiator or a thermal polymerization initiator for the light irradiation or the high temperature treatment is not essentially required. Considering the storage stability of the coating solution, it is preferable not to use the photopolymerization initiator or the thermal polymerization initiator.

<Method for Manufacturing Antibacterial Layer>

The antibacterial layer contains the respective components described above. The method for forming the antibacterial layer is not particularly limited, but it is preferable to use a method for forming the antibacterial layer by using the coating solution (corresponding to an antibacterial solution) containing the various components described above, because then the thickness of the antibacterial layer is easily controlled, and the manufacturing place can be easily controlled.

Hereinafter, the method using the coating solution will be specifically described.

Examples of the aforementioned method for manufacturing the antibacterial layer include a method for forming an antibacterial layer by coating a support, which will be described later, with the coating solution containing at least the binder and the antibacterial agent described above and performing a drying treatment if necessary.

The coating solution contains at least the binder and the antibacterial agent. The coating solution may further contain the antistatic agent (for example, metal oxide particles), the silica particles, the surfactant, the catalyst, the dispersant, the solvent, and other additives described above.

A ratio of a mass of a solid content with respect to a total mass of the coating solution is preferably 0.1% to 30% by mass, more preferably 0.2% to 20% by mass, and even more preferably 0.5% to 10% by mass.

As described above, the coating solution may contain a solvent (water or an organic solvent). In view of further improving the effects of the present invention, the coating solution preferably contains water. Particularly, in view of further improving the effects of the present invention, the content of water is, with respect to a total mass of the coating solution (antibacterial solution), preferably equal to or greater than 10% by mass, and more preferably equal to or greater than 40% by mass. The upper limit thereof is not particularly limited, but is equal to or less than 99% by mass in many cases.

The content rate of the binder (particularly, a siloxane oligomer) in the coating solution is, with respect to the mass of the total solid content of the coating solution, preferably 3% to 70% by mass, more preferably 5% to 60% by mass, and even more preferably 10% to 50% by mass. If the content rate of the binder (particularly, the siloxane oligomer) is within the above range, it is possible to form an antibacterial layer having appropriate hardness and durability.

The content of the antibacterial agent in the coating solution is not particularly limited. In view of the balance between contaminant removability and antibacterial properties, the content of the antibacterial agent is, with respect to the mass of the total solid content of the coating solution, preferably 0.001 to 15 wt %, more preferably 0.001 to 10 wt %, and even more preferably 0.001 to 5 wt %.

The content of the antistatic agent (particularly, metal oxide particles) in the coating solution is not particularly limited. Particularly, the content rate of the metal oxide fine particles is, with respect to the mass of the total solid content of the coating solution, preferably equal to or less than 70% by mass, more preferably equal to or less than 60% by mass, and even more preferably equal to or less than 50% by mass. If the content rate of the metal oxide fine particles is within the above range, it is possible to effectively impart antistatic properties without impairing the film formability of the antibacterial layer.

The content rate of the metal oxide fine particles is, with respect to a total mass of the coating solution, preferably equal to or less than 30% by mass, more preferably equal to or less than 20% by mass, and even more preferably equal to or less than 10% by mass. If the proportion of the metal oxide fine particles is within the above range, the dispersibility of the metal oxide fine particles in the coating solution can be improved, and it is possible to impart antistatic properties without causing a problem of aggregation of the metal oxide fine particles.

The content of the silica particles in the coating solution is not particularly limited. The content rate of the silica fine particles is, with respect to the mass of the total solid content of the coating solution, preferably 5% to 95% by mass, more preferably 10% to 90% by mass, and even more preferably 20% to 80% by mass. If the proportion of the silica fine particles is within the above range, it is possible to form an extremely hard antibacterial layer which is excellent in scratch resistance and impact resistance and has hydrophilicity.

On the other hand, the content rate of the silica fine particles is, with respect to a total mass of the coating solution, preferably equal to or less than 30% by mass, more preferably equal to or less than 20% by mass, and even more preferably equal to or less than 10% by mass. If the proportion of the silica fine particles is within the above range, the dispersibility of the silica fine particles in the coating solution can be improved, and it is possible to form the aforementioned antibacterial layer without causing a problem of aggregation of the silica fine particles.

The content of the surfactant (component exhibiting surface activity) in the coating solution is not particularly limited. The content of the component exhibiting surface activity may be, with respect to a total mass of the coating solution, equal to or greater than 0.01% by mass, and is preferably equal to or greater than 0.02% by mass and more preferably equal to or greater than 0.03% by mass. The upper limit thereof is not particularly limited, but is equal to or less than 5.0% by mass with respect to a total mass of the coating solution in many cases. The upper limit is particularly preferably equal to or less than 1.0% by mass.

If the content of the surface-active component is within the above range, wettability can be improved, and the coating properties of the coating solution can be improved. In contrast, if an excess of surface-active component is added, the component may be segregated onto the surface after the coating of the coating solution, and hence the hardness of the film may deteriorate. Therefore, the amount of the surface-active component is, with respect to the mass of the total solid content of the coating solution, preferably equal to or less than 10% by mass, more preferably equal to or less than 8% by mass, and even more preferably equal to or less than 5% by mass.

The content of the catalyst, which accelerates the condensation of the siloxane oligomer, in the coating solution is not particularly limited. The content rate of the catalyst accelerating the condensation of the siloxane oligomer is, with respect to the mass of the total solid content of the coating solution, preferably 0.1% to 20% by mass, more preferably 0.2% to 15% by mass, and even more preferably 0.3% to 10% by mass. If the content rate of the catalyst is within the above range, it is possible to form an antibacterial layer having appropriate hardness and durability, and the antibacterial layer can be formed at an appropriate speed.

The content rate of the aforementioned dispersant in the coating solution is, with respect to a total mass of the coating solution, preferably 0.1% to 30% by weight, and more preferably 0.1% to 20% by weight. If the content rate of the dispersant is within the above range, it is possible to improve the dispersibility of particles in the coating solution and to improve scratch resistance.

In the present invention, a carbon compound contained in the coating solution in a minimum amount is preferably a low-molecular weight compound. Specifically, the content rate of an organic compound having a molecular weight of equal to or greater than 1,100 contained in the total solid content of the coating solution is preferably equal to or less than 0.2% by mass, more preferably 0.1% by mass, and even more preferably 0% by mass. If the content of the organic compound is within the above range, it is possible to improve the compatibility of the solid content of the coating solution and to improve the film formability of the antibacterial layer after coating•drying.

(Method for Preparing Coating Solution)

The coating solution is obtained by mixing together the respective components described above.

Particularly, in a suitable aspect of the coating solution of the present invention, the coating solution is obtained by mixing a siloxane oligomer with a water component, an antistatic agent, and silica fine particles. It is preferable that the siloxane oligomer is first mixed with the water component such that a hydrolysate of the siloxane oligomer is obtained. At this time, it is preferable to add the catalyst accelerating the condensation of the siloxane oligomer. In this way, a solution of a siloxane oligomer hydrolysate is obtained.

The antistatic agent and the silica fine particles are further added to the solution of the solution of the siloxane oligomer hydrolysate. Herein, it is preferable to further add a surfactant as a wettability improving agent. At this time, the catalyst accelerating the condensation of the siloxane oligomer may be added. Furthermore, a portion or all of the antistatic agent or the surfactant may be added in the step of obtaining the siloxane oligomer hydrolysate.

As another suitable aspect of the coating solution, a coating solution (antibacterial solution) is exemplified which contains a siloxane oligomer represented by Formula (1) described above, an antibacterial agent, a surfactant, and silica particles having a mean particle size of equal to or less than 100 nm.

It is preferable that the coating solution contains an ionic surfactant as the surfactant.

In addition, it is preferable that the coating solution further contains water, and the content of water is preferably equal to or greater than 40% by mass with respect to a total mass of the coating solution (antibacterial solution).

The preparation conditions of the coating solution are not particularly limited. Some of the silica fine particles used are aggregated depending on the pH or the concentration of the coexisting components. Accordingly, it is preferable that the silica fine particles are added at a later stage of the preparation of the coating solution, preferably at the final stage. At this time, in a case where a dispersion of the silica fine particles is used, it is preferable that both of the pH of the dispersion and the pH of the coating solution are made acidic or basic.

(Method for Forming Antibacterial Layer)

The antibacterial layer of the present invention can be formed by performing coating by using the aforementioned coating solution and drying the coating solution. The subject to be coated with the coating solution is not particularly limited, and as will be described later, the surface of various supports such as glass, a resin, a metal, and ceramic is suitably used. In a case where glass is used as a support, for example, due to the occurrence of condensation between a hydroxyl group on silicon derived from the siloxane oligomer and a hydroxyl group of the glass surface, a laminate excellent in adhesiveness is obtained.

The coating method of the coating solution of the present invention is not particularly limited, and examples thereof include spray coating, brush coating, roller coating, bar coating, dip coating, and the like. As a drying method used after coating, the coating solution may be dried at room temperature or heated for about 1 to 30 minutes at 40° C. to 120° C.

By scattering the coating solution through spray coating and curing the coating solution, the antibacterial layer can be disposed in a curved portion on which the antibacterial layer is not easily disposed (boned).

<Antibacterial Sheet>

Next, an antibacterial sheet according to an embodiment of the present invention will be described below.

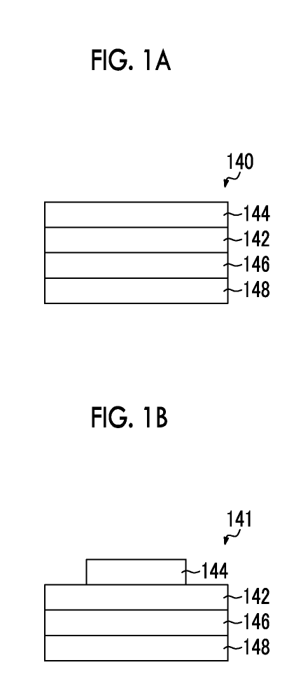

As shown in FIG. 1A, an antibacterial sheet 140 of the present invention has a support (main sheet) 142, an antibacterial layer 144 which is formed on one external surface of the support 142, a pressure sensitive adhesive layer 146 which is formed on the other surface of the support 142 that is on the side opposite to one external surface, and a release sheet 148 which is laminated on a surface of the pressure sensitive adhesive layer 146 that is on the side opposite to the support 142.

The antibacterial sheet of the present invention is not limited to an embodiment in which the antibacterial layer 144 is formed on the entirety of one outer surface of the support 142 as in the antibacterial sheet 140 shown in FIG. 1A. The antibacterial sheet of the present invention may be constituted such that the antibacterial layer 144 is formed on a portion of one outer surface of the support 142 as in an antibacterial sheet 141 shown in FIG. 1B.

The antibacterial sheets 140 and 141 of the present invention are for forming the laminate of the antibacterial layer 144 and the support 142 on various instruments.

In the examples shown in FIGS. 1A and 1B, the antibacterial sheets 140 and 141 have the pressure sensitive adhesive layer 146. Therefore, by peeling a release sheet 148 from the pressure sensitive adhesive layer 146, the pressure sensitive adhesive layer 146 can be bonded to various instruments described above.

In the examples shown in FIGS. 1A and 1B, the antibacterial sheets 140 and 141 have the pressure sensitive adhesive layer 146 in addition to the laminate of the antibacterial layer 144 and the support 142. However, the present invention is not limited thereto, and the protective sheets 144 and 142 may be constituted only with the laminate of the antibacterial layer 144 and the support 142. In a case where the antibacterial sheets 140 and 141 are constituted only with the laminate of the antibacterial layer 144 and the support 142, by additionally forming an adhesive layer or the like by means of coating the antibacterial layer forming surface or a surface of the support 142 with an adhesive or the like, and bonding the laminate of the antibacterial layer 144 and the support 142 to the antibacterial layer forming surface of various instruments, the antibacterial layer 144 can be formed.

The antibacterial layer 144 is a layer containing at least the aforementioned binder or antibacterial agent, and may contain other components.

The antibacterial layer preferably contains the aforementioned binder (for example, a hydrophilic polymer or a siloxane compound) as a main component. Herein, the main component means that the content of the binder is equal to or greater than 20 wt % with respect to a total mass of the antibacterial layer. The content of the binder is preferably equal to or greater than 30 wt %, and more preferably equal to or greater than 50 wt %.

The content of the antibacterial agent in the antibacterial layer is not particularly limited. In view of the balance between contaminant removability and antibacterial properties, the content of the antibacterial agent is, with respect to a total mass of the antibacterial layer, preferably 0.001 to 15 wt %, more preferably 0.001 to 10 wt %, and even more preferably 0.001 to 5 wt %.

In a case where a silver-containing inorganic antibacterial agent and other antibacterial agents are used as the antibacterial agent, a total content of the antibacterial agent should be within the above range, and the content of other antibacterial agents may be equal to or less than 50 wt % with respect to the total amount of the antibacterial agent (or the amount of the silver-containing inorganic antibacterial agent), and preferably equal to or less than 20 wt %.

In a case where silver particles are used as an antibacterial agent, the content of the antibacterial agent in the antibacterial layer is, with respect to a total mass of the antibacterial layer, preferably 0.001 to 5 wt %, more preferably 0.001 to 2 wt %. even more preferably 0.001 to 1 wt %, and particularly preferably 0.001 to 0.1 wt %. If the content is equal to or greater than 0.001 wt %, the antibacterial effect can be further improved. If the content is equal to or less than 5 wt %, hydrophilicity is not reduced, temporal properties do not deteriorate, and antifouling properties are not negatively affected.

The content of the silver-based antibacterial agent in the antibacterial layer should be within the above range. In view of further improving the effects of the present invention, it is preferable that the silver-based antibacterial agent is incorporated into the antibacterial layer such that the content of silver with respect to a total mass of the antibacterial layer becomes 0.001 to 20 wt % (more preferably 0.001 to 10 wt %, and particularly preferably 0.001 to 5 wt %).

In a case where an organic silver-containing antibacterial agent is used as a silver-based antibacterial agent, the content of the antibacterial agent should fall into the above range. In view of further improving mechanical strength of the antibacterial layer and improving the effects of the present invention, the content of the antibacterial agent is preferably 1 to 5 wt % with respect to a total mass of the antibacterial layer.

In a case where an inorganic silver-based antibacterial agent is used as a silver-based antibacterial agent, the content of the antibacterial agent should fall into the above range. In view of further improving mechanical strength of the antibacterial layer and improving the effects of the present invention, the content of the antibacterial agent is preferably 0.001 to 10 wt % and more preferably 0.01 to 5 wt % with respect to a total mass of the antibacterial layer.

In a case where silver ceramic particles (silver-supporting ceramic) are used, if the content thereof is equal to or greater than 0.1 wt % with respect to a total mass of the antibacterial layer, the antibacterial effect can be further improved. If the content is smaller than 10 wt %, hydrophilicity is not reduced, temporal properties do not deteriorate, and antifouling properties are not negatively affected.

In a case where an organic antibacterial agent is used in addition to the silver-containing antibacterial agent as the antibacterial agent, in view of the balance between contaminant removability and antibacterial properties, the content of the organic antibacterial agent with respect to a total mass of the antibacterial agent is preferably 0.0005 to 2.5 wt %.

In the present invention, the antibacterial agent may not be exposed on a surface of the antibacterial layer.

Furthermore, the antibacterial layer may contain other components in addition to the aforementioned binder (the hydrophilic polymer and the siloxane compound) and the antibacterial agent.

In a case where the antibacterial agent contains metal oxide fine particles, the content of the metal oxide fine particles is, with respect to a total mass of the antibacterial layer, preferably equal to or less than 70% by mass, more preferably equal to or less than 60% by mass, and even more preferably equal to or less than 50% by mass. The lower limit thereof is not particularly limited, but is equal to or greater than 1% by mass in many cases. If the content rate of the metal oxide fine particles is within the above range, it is possible to effectively impart antistatic properties without impairing film formability of the antibacterial layer.

The content of the silica fine particles is, with respect to a total mass of the antibacterial layer, preferably 5% to 95% by mass, more preferably 10% to 90% by mass, and even more preferably 20% to 80% by mass. If the proportion of the silica fine particles is within the above range, it is possible to form an extremely hard antibacterial layer which is excellent in scratch resistance and impact resistance and has hydrophilicity.

In a case where the antibacterial agent contains a surfactant, the content of the surfactant is, with respect to a total mass of the antibacterial layer, preferably equal to or less than 10% by mass, more preferably equal to or less than 8% by mass, and even more preferably equal to or less than 5% by mass. The lower limit thereof is not particularly limited, but is equal to or greater than 0.1% by mass in many cases.

In a case where the antibacterial agent contains the catalyst accelerating the condensation of the siloxane oligomer, the content of the catalyst accelerating the condensation of the siloxane oligomer is, with respect to a total mass of the antibacterial layer, preferably 0.1 to 20% by mass, more preferably 0.2 to 15% by mass, and even more preferably 0.3 to 10% by mass. If the content of the catalyst is within the above range, an antibacterial layer having appropriate hardness and durability can be formed, and the antibacterial layer can be formed at an appropriate speed.

In a case where the antibacterial agent contains a dispersant, the content of the dispersant is preferably 0.1% to 30% by mass, and more preferably 0.2% to 20% by mass, with respect to a total mass of the antibacterial layer.

The support 142 supports the antibacterial layer 144 formed on the entirety or a portion of one outer surface thereof. The antibacterial layer 144 may be formed on the entirety or a portion of one outer surface of the support 142. It is preferable that the antibacterial layer 144 is formed on the entirety of one outer surface of the main sheet 142.

The support 142 is not particularly limited as long as it can support the antibacterial layer 144, and any type of sheet may be used. As the support 142, a known sheet can be used. For example, it is possible to use a polyethylene terephthalate film (PET), triacetyl cellulose (TAC), polycarbonate (PC), a polybutylene terephthalate film (PBT), a polyimide film, and the like. Among these, in view of ease of handling, transparency, or the like, polyethylene terephthalate film (PET), triacetyl cellulose (TAC), and polycarbonate (PC) are preferable. As PET, for example, it is possible to use LUMIRROR U34 manufactured by TORAY INDUSTRIES, INC, COSMOSHINE A4300 manufactured by Toyobo Co., Ltd, 03916W manufactured by TEIJIN LIMITED, and the like. Furthermore, an easily adhesive layer may be provided on a surface thereof.

The thickness of the support 142 is not particularly limited, and those having a thickness of 10 μm to 200 μm can be used. In a case where the subject to which laminate of the antibacterial layer 144 and the support 142 is to be bonded is a resistive film-type touch panel, the laminate needs to conform to a flexible surface, and hence the thickness of the support 142 is 10 μm to 100 μm and preferably 10 μm to 50 μm. In a case of a capacitance-type touch panel, in view of ease of bonding, it is possible to preferably use a support 142 having a thickness of 50 μm to 100 μm.

The pressure sensitive adhesive layer 146 is used for bonding the laminate of the antibacterial layer 144 and the support 142 to the antibacterial layer forming surface of the various instruments. The pressure sensitive adhesive layer 146 is not particularly limited as long as it enables the laminate of the antibacterial layer 144 and the support 142 to be bonded to various antibacterial layer forming surfaces, and may be formed using a known pressure sensitive adhesive. The pressure sensitive adhesive usable in the pressure sensitive adhesive layer 146 is not particularly limited, and examples thereof include a (meth)acrylic pressure sensitive adhesive, a rubber-based pressure sensitive adhesive, a silicone-based pressure sensitive adhesive, a urethane-based pressure sensitive adhesive, a polyester-based pressure sensitive adhesive, and the like. In a case where the pressure sensitive adhesive layer is used for a surface of a touch panel, considering the facts that the pressure sensitive adhesive layer is repeatedly bonded and peeled and needs to be bonded while preventing air bubbles from entering, it is also possible to preferably use a self-adhesive pressure sensitive adhesive. Herein, the (meth)acrylic pressure sensitive adhesive refers to an acrylic pressure sensitive adhesive and/or a methacrylic pressure sensitive adhesive (methacrylic pressure sensitive adhesive). As the (meth)acrylic pressure sensitive adhesive, it is possible to use a (meth)acrylic pressure sensitive adhesive used in a pressure sensitive sheet.

A method for forming a pressure sensitive adhesive layer is not particularly limited, and examples thereof include a coating method, a printing method, a bonding method, and the like. Among these, it is possible to preferably use a method of installing the pressure sensitive adhesive layer by coating and a method of forming the pressure sensitive adhesive layer by bonding a pressure sensitive sheet, and the method of forming the pressure sensitive adhesive layer by bonding a pressure sensitive sheet is more preferable.

The thickness of the pressure sensitive adhesive layer 146 is not particularly limited, and is preferably 1 μm to 30 μm. If the thickness of the pressure sensitive adhesive layer is equal to or greater than 1 μm, the layer can be stably formed by co-extrusion. If the thickness is equal to or less than 30 μm, costs of the material are reduced. For enhancing pressure sensitive adhesion, it is preferable to increase the thickness of the pressure sensitive adhesive layer in consideration of the viscosity thereof, because a contact area between the pressure sensitive adhesive layer and an object covered with the pressure sensitive adhesive layer easily increases if the thickness of the pressure sensitive adhesive layer increases. The thickness of the pressure sensitive adhesive layer is preferably 2 μm to 20 μm, and more preferably 3 μm to 15 μm.

The pressure sensitive adhesion of the pressure sensitive adhesive layer 146 is not particularly limited, and is preferably within a range of 2 cN/25 mm to 20 cN/25 mm for use. If the pressure sensitive adhesion is equal to or greater than 2 cN/25 mm, when the pressure sensitive adhesive layer is used by being bonded to a surface of a touch panel or the like, the pressure sensitive adhesive layer is not easily detached. If the pressure sensitive adhesion is equal to or less than 20 cN/25 mm, the film can be smoothly peeled off at the time of peeling.

The release sheet 148 remains bonded to the pressure sensitive adhesive layer 146 until the antibacterial sheet 140 is used so as to protect the pressure sensitive adhesive layer 146. The release sheet 148 is not particularly limited as long as it can protect the pressure sensitive adhesive layer 146, and a known release sheet 148 can be used. For example, it is possible to use a release agent such as a silicone-based compound, a long-chain alkyl-based compound, or polyvinyl alcohol•carbamate.

The thickness of the release sheet 148 is not particularly limited, and is preferably 1 μm to 30 μm. If the thickness of the release sheet is equal to or greater than 1 μm, the film can be stably formed by co-extrusion. If the thickness is equal to or less than 30 μm, costs of the material are reduced. The thickness of the release sheet is preferably 2 μm to 20 μm, and more preferably 3 μm to 15 μm.

(Water Contact Angle)

In order to improve antifogging properties, the water contact angle of the surface of the antibacterial layer is preferably equal to or less than 20°, and more preferably equal to or less than 10°

The lower limit thereof is not particularly limited, but is equal to or greater than 3° in many cases in view of the characteristics of materials used.

In the present specification, the water contact angle is measured based on a sessile drop method of JIS R 3257:1999. For measuring the water contact angle, LSE-ME1 (software twin mini) manufactured by NiCK Corporation is used. More specifically, at room temperature (20° C.), 2 μl of droplets of pure water are added dropwise onto a surface of the antibacterial layer which is kept horizontal, and a contact angle at a point in time when 20 seconds has elapsed from the dropping is measured.

(Thickness of Antibacterial Layer)

The thickness of the antibacterial layer is not particularly limited. In view of antifogging properties or antibacterial properties, the thickness is preferably equal to or less than 10 μm, more preferably equal to or less than 3 and most preferably equal to or less than 1 The lower limit thereof is not particularly limited, but is equal to or greater than 0.01 μm in many cases.

The thickness of the antibacterial layer refers to an average thickness, and as the method for measuring it, for example, there is a method in which a sample piece including the antibacterial layer is embedded in a resin, a section thereof is cut with a microtome, and the cut section is observed with a scanning electron microscope so as to measure the average thickness. The thicknesses in 10 random points in the antibacterial layer are measured, and an arithmetic mean thereof is calculated.

The surface of the antibacterial layer does not need to be subjected to a special surface treatment, and may remain as a flat surface after being prepared.

(Haze)

The haze of the antibacterial sheet is not particularly limited. In view of further improving transparency, the haze is preferably equal to or less than 10%, more preferably equal to or less than 3%, and even more preferably equal to or less than 1%. The lower limit thereof is not particularly limited, but is equal to or greater than 0.1% in many cases.

The haze is measured by the method based in JIS K7361.

(Root Mean Square Roughness)

The root mean square roughness of the surface of the antibacterial layer is not particularly limited, but is preferably equal to or less than 0.1 μm, more preferably equal to or less than 0.05 μm, even more preferably equal to or less than 0.01 μm. The lower limit is not particularly limited, but is preferably equal to or greater than 0.001 μm.

The root mean square roughness of the surface of the antibacterial layer is determined based on JIS B 0601.

(Surface Electrical Resistance)

The surface electrical resistance of the surface of the antibacterial layer is not particularly limited. The surface electrical resistance is preferably equal to or less than 10¹⁰ Ω/square, more preferably equal to or less than 10⁹ Ω/square, and even more preferably equal to or less than 10⁸ Ω/square, because then the adherence of dust caused by charging ca be further inhibited. The lower limit thereof is not particularly limited, but is equal to or greater than 10⁶ Ω/square in many cases.

The surface electrical resistance is measured by the following method.

First, the surface electrical resistance is measured at a temperature of 25° C. in an environment with a relative humidity of 60% RH. By using a device, which is obtained by connecting a resistivity chamber R12704A (manufactured by ADVANTEST CORPORATION) to a digital electrometer R8252 (manufactured by ADVANTEST CORPORATION), as a measurement device, a surface resistivity is measured based on JIS K 6911. The unit thereof is Ω/square (=Ω/sq).

(Extraction Test)

The antibacterial sheet including the aforementioned support and antibacterial layer is not particularly limited in terms of the amount of silver ions per unit area that is measured by an extraction test which will be described later. In view of further improving the effects of the present invention, the amount of silver ions is preferably equal to or greater than 0.01 ng/cm², more preferably equal to or greater than 10 ng/cm², and even more preferably equal to or greater than 15 ng/cm².

Hereinafter, the extraction test method will be specifically described.

In the extraction test, a 1/500 normal nutrient broth medium specified in JIS Z 2801:2010 is used as an extractant. The temperature of the extractant is controlled within a range of 35±1° C., and the extractant (amount: 9 mL) is brought into contact with the antibacterial layer (area of antibacterial layer: 4 cm² (2 cm×2 cm)) in the antibacterial sheet for 1 hour. As the method for bringing the antibacterial layer into contact with the extractant, a method of impregnating the antibacterial sheet with the extractant is performed.

Then, after 1 hour, the antibacterial sheet is recovered from the extractant, and the amount of silver ions (ng) extracted from the extractant is measured. The amount of silver ions in the extractant is measured using atomic absorption spectrometer (contrAA700 manufactured by Analytik Jena AG), and from the calibration curve prepared in advance, the amount of silver ions is determined.

At the time of measuring the amount of silver ions, if necessary, it is preferable to add nitric acid (about 1 mL) to the extractant such that the stability of the measurement is improved.

Next, the obtained amount of silver ions is divided by the contact area (4 cm²) between the antibacterial layer and the extractant, thereby calculating an amount of silver ions (ng/cm²) per unit area. The contact area between the antibacterial layer and the extractant refers to an area in which the surface of the antibacterial layer contacts the extractant when the antibacterial layer is brought into contact with the extractant.

The obtained amount of silver ions shows how many silver ions are eluted (extracted) from the antibacterial layer.

As another aspect of the present invention, an antibacterial coat is exemplified.

The antibacterial coat has the same constitution as the aforementioned antibacterial layer. That is, while the antibacterial sheet has an aspect in which it includes a support and an antibacterial layer, the antibacterial coat is constituted only with an antibacterial layer.

The constitution of the antibacterial coat is the same as the aforementioned antibacterial layer and includes at least a binder and an antibacterial agent. The water contact angle of only the binder is within a predetermined range.

Furthermore, the range of the water contact angle, the thickness, the haze, the root mean square roughness, the surface electrical resistance, and the amount of eluted silver of the antibacterial coat is the same as the range of the water contact angle, the thickness, the root mean square roughness, the surface electrical resistance, the amount of eluted silver, and the haze of the antibacterial sheet of the aforementioned antibacterial layer, and suitable ranges thereof are also the same.

In view of further improving the effects of the present invention, the antibacterial coat contains a binder, an antibacterial agent, a surfactant, and silica particles having a mean particle size of equal to or less than 100 nm, in which the binder is preferably formed using a siloxane oligomer represented by Formula (1) described above.

A laminate may be formed by laminating a plurality of layers of antibacterial sheets.

Each of the antibacterial agents contained in the antibacterial sheet in the laminate may be of different kinds.

### EXAMPLES

Hereinafter, the present invention will be specifically described using examples, but the present invention is not limited thereto.

### Example 1

3.06 g of siloxane oligomers (n=5) represented by Formula (1), and 0.94 g of a 1% isopropanol solution of aluminum bis(ethylacetoacetate)mono(acetylacetonate) were added to and mixed with 81.07 g of ethanol. 114.80 g of water, in which 0.057 g of polyethylene glycol monolauryl ether (number of repeating ethylene oxide portions: 15) dissolved, was slowly added to the obtained solution, followed by stirring for 12 hours or longer at room temperature such that the siloxane oligomers were hydrolyzed, thereby preparing a base solution of a coating agent.

Then, 19.99 g of the base solution of a coating agent was diluted by the addition of 7.36 g of ethanol 12.58 g of water, 0.0056 g of polyethylene glycol monolauryl ether (number of repeating ethylene oxide portions: 15), and 0.0011 g of sodium di(2-ethylhexyl)sulfosuccinate. 0.85 g of a 1% isopropanol solution of aluminum bis(ethylacetoacetate)mono(acetylacetonate) and 1.70 g of a 33% dispersion of silica fine particles (mean particle size: 10 to 15 nm) were added thereto, thereby preparing a binder coating solution L-1(b). An easy adhesion-treated surface of PET, in which one surface thereof was subjected to an easy adhesion treatment, was coated with a binder coating solution L-1(b) by using a #8 bar coater, followed by drying for 1 hour at room temperature, thereby obtaining a sheet S-1(b) coated only with a binder.

Furthermore, “BACTELITE MP-102SVC13” (dispersion medium; isopropyl alcohol (IPA), concentration of solid contents: 25%), which is silver-supporting ceramic manufactured by Fuji Chemical Industry Co., Ltd., was added at a proportion of 0.0084 g with respect to 100 g of the binder coating solution L-1(b), followed by stirring for 15 minutes, thereby obtaining a coating solution L-1. An easy adhesion-treated surface of PET, in which one surface thereof was subjected to an easy adhesion treatment, was coated with the coating solution L-1 by using a #8 bar coater, followed by drying for 1 hour at room temperature. Thereafter, onto the surface opposite to the coated surface, a pressure sensitive adhesive film (manufactured by PANAC Corporation, GELPOLY (mount type)) was bonded using a laminator, thereby obtaining an antibacterial sheet S-1.

### Example 2

A coating solution L-2 was prepared in the same manner as in Example 1, except that the proportion of the BACTELITE MP-102SVC13 added was changed to 0.084 g from 0.0084 g. Furthermore, by using the coating solution L-2, an antibacterial sheet S-2 was obtained in the same manner as in Example 1.

### Example 3

A coating solution L-3 was prepared in the same manner as in Example 1, except that the proportion of the BACTELITE MP-102SVC13 added was changed to 0.84 g from 0.0084 g. Furthermore, by using the coating solution L-3, an antibacterial sheet S-3 was obtained in the same manner as in Example 1.

### Example 4

(1) Preparation of Reactive Silane Solution

In a state where 190.88 g of ethanol was being stirred in a container, 7.20 g of a siloxane-based binder (“MKC (registered trademark) SILICATE MS51” manufactured by Mitsubishi Chemical Corporation) and 2.21 g of an aluminum chelate D (aluminum bisethylacetoacetate•monoacetyl acetonate, concentration of solid contents: 1%) were added thereto. Then, a solution, which was obtained by dissolving 27.07 g of a nonionic surfactant (“EMALEX 715” manufactured by NIHON EMULSION Co., Ltd., concentration of solid contents: 0.5 wt %) in 243.33 g of pure water, was added thereto little by little by using a pipette, followed by stifling for 12 hours, thereby obtaining a reactive silane solution.

(2) Preparation of Coating Solution and Sheet Sample

In a state where the reactive silane solution obtained in (1) was being stirred, 256.77 g of water, 172.98 g of ethanol, 20.00 g of an aluminum chelate D (aluminum bisethylacetoacetate•monoacetyl acetonate, concentration of solid contents: 1%), 23.36 g of a nonionic surfactant (“EMALEX 715” manufactured by NIHON EMULSION Co., Ltd., concentration of solid contents: 0.5 wt %), 13.18 g of sodium di(2-ethylhexyl)sulfosuccinate (concentration of solid contents: 0.2%) as an anionic surfactant, and 40.01 g of silica particles (“SNOWTEX O-33” manufactured by NISSAN CHEMICAL INDUSTRIES, LTD., mean particle size: 10 to 20 nm, concentration of solid contents: 33%) were sequentially added thereto, followed by stirring for 1 hour, thereby obtaining a binder coating solution L-4(b). An easy adhesion-treated surface of PET, in which one surface thereof was subjected to an easy adhesion treatment, was coated with the binder coating solution L-4(b) by using a #8 bar coater, followed by drying for 1 hour at room temperature, thereby obtaining a sheet S-4(b) coated only with a binder.

Furthermore, “BACTELITE MP-102SVC13” (dispersion medium: IPA, concentration of solid contents: 25%), which is silver-supporting ceramic, was added at a proportion of 0.0084 g with respect to 100 g of the binder coating solution L-4(b), followed by stirring for 15 minutes, thereby obtaining a coating solution L-4. An easy adhesion-treated surface of PET, in which one surface thereof was subjected to an easy adhesion treatment, was coated with the coating solution L-4 by using a #8 bar coater, followed by drying for 1 hour at room temperature. Thereafter, onto the surface opposite to the coated surface, a pressure sensitive adhesive film (manufactured by PANAC Corporation, GELPOLY (mount type)) was bonded using a laminator, thereby obtaining an antibacterial sheet S-4.

### Example 5

A coating solution L-5 was prepared in the same manner as in Example 4, except that the proportion of BACTELITE MP-102SVC13 added was changed to 0.084 g from 0.0084 g. Furthermore, by using the coating solution L-5, an antibacterial sheet S-5 was obtained in the same manner as in Example 4.

### Example 6

A coating solution L-6 was prepared in the same manner as in Example 4, except that the proportion of BACTELITE MP-102SVC13 added was changed to 0.84 g from 0.0084 g. Furthermore, by using the coating solution L-6, an antibacterial sheet S-6 was obtained in the same manner as in Example 4.

### Example 7

An antibacterial sheet S-7 was obtained by the same method as in Example 4, except for a #50 bar coater was used instead of the #8 bar coater.

### Example 8

An antibacterial sheet S-8 was obtained by the same method as in Example 5, except for a #50 bar coater was used instead of the #8 bar coater.

### Example 9

An antibacterial sheet S-9 was obtained by the same method as in Example 6, except for a #50 bar coater was used instead of the #8 bar coater.

### Example 10

(1) Preparation of Reactive Silane Solution

In a state were 67.32 g of ethanol was being stirred in a container, 19.10 g of a siloxane-based binder (“MKC (registered trademark) SILICATE MS51” manufactured by Mitsubishi Chemical Corporation) and 5.90 g of aluminum chelate D (aluminum bisethylacetoacetate•monoacetyl acetonate, concentration of solid contents: 1%) were added thereto. Then, a solution, which was obtained by dissolving 71.90 g of a nonionic surfactant (“EMALEX 715” manufactured by NIHON EMULSION Co., Ltd., concentration of solid contents: 0.5 wt %) in 85.78 g of pure water, was added thereto little by little by using a pipette, followed by stirring for 12 hours, thereby obtaining a reactive silane solution.

(2) Preparation of Coating Solution and Sheet Sample

In a state where 93.44 g of the reactive silane solution obtained in (1) was being stirred, 1.926 g of water, 0.40 g of ethanol, 19.90 g of an aluminum chelate D (aluminum bisethylacetoacetate•monoacetyl acetonate, concentration of solid contents: 1%), 31.30 g of a nonionic surfactant (“EMALEX 715” manufactured by NIHON EMULSION Co., Ltd., concentration of solid contents: 0.5 wt %), 14.50 g of sodium di(2-ethylhexyl) sulfosuccinate (concentration of solid contents: 0.2%) as an anionic surfactant, and 39.70 g of silica particles (“SNOWTEX O-33” manufactured by NISSAN CHEMICAL INDUSTRIES, LTD., concentration of solid contents: 33%) were sequentially added thereto, followed by stirring for 1 hour, thereby obtaining a binder coating solution L-10(b). An easy adhesion-treated surface of PET, in which one surface thereof was subjected to an easy adhesion treatment, was coated with the binder coating solution L-10(b) by using a #36 bar coater, followed by drying for 1 hour at room temperature, thereby obtaining a sheet S-10(b) coated only with a binder.

Furthermore, “BACTELITE MP-102SVC13” was added at a proportion of 0.040 g with respect to 100 g of the binder coating solution L-10(b), followed by stirring for 15 minutes, thereby obtaining a coating solution L-10. An easy adhesion-treated surface of PET, in which one surface thereof was subjected to an easy adhesion treatment, was coated with the coating solution L-10 by using a #36 bar coater, followed by drying for 1 hour at room temperature. Thereafter, onto the surface opposite to the coated surface, a pressure sensitive adhesive film (manufactured by PANAC Corporation, GELPOLY (mount type)) was bonded using a laminator, thereby obtaining an antibacterial sheet S-10.

### Example 11

A coating solution L-11 was prepared in the same manner as in Example 10, except that the proportion of BACTELITE MP-102SVC13 added was changed to 0.40 g from 0.040 g. Furthermore, by using the coating solution L-11, an antibacterial sheet S-11 was obtained in the same manner as in Example 4.

### Example 12

A coating solution L-12 was prepared in the same manner as in Example 10, except that the proportion of BACTELITE MP-102SVC13 added was changed to 4.0 g from 0.040 g. Furthermore, by using the coating solution L-12, an antibacterial sheet S-12 was obtained in the same manner as in Example 4.

### Example 13

By dispersing “BACTELITE BM-103CI-Z” (silver-supporting glass powder) manufactured by Fuji Chemical Industry Co., Ltd. in IPA at a concentration of solid contents of 25%, thereby preparing an antibacterial agent dispersion. The antibacterial agent dispersion was added to the binder coating solution L-4(b) of Example 4, at a proportion of 0.0084 g with respect to 100 g L-4(b), followed by stirring for 15 minutes, thereby obtaining a coating solution L-13. An easy adhesion-treated surface of PET, in which one surface thereof was subjected to an easy adhesion treatment, was coated with the coating solution L-13 by using, a predetermined bar coater, followed by drying for 1 hour at room temperature. Thereafter, onto the surface opposite to the coated surface, a pressure sensitive adhesive film (manufactured by PANAC Corporation, GELPOLY (mount type)) was bonded using a laminator, thereby obtaining an antibacterial sheet S-13.

### Example 14

A coating solution L-14 was prepared in the same manner as in Example 13, except that the proportion of the antibacterial agent dispersion added was changed to 0.084 g from 0.0084 g. Furthermore, by using the coating solution L-14, an antibacterial sheet S-14 was obtained in the same manner as in Example 4.

### Example 15

A coating solution L-15 was prepared in the same manner as in Example 13, except that the proportion of the antibacterial agent dispersion added was changed to 0.84 g from 0.0084 g. Furthermore, by using the coating solution L-15, an antibacterial sheet S-15 was obtained in the same manner as in Example 4.

### Example 16

By dispersing silver particles having a mean particle size of 0.01 μm in butyl acetate at a concentration of solid contents of 1%, thereby obtaining an antibacterial agent dispersion. The antibacterial agent dispersion was added to the binder coating solution L-4(b) of Example 4, at a proportion of 0.0084 g with respect to 100 a of L-4(b), followed by stirring for 15 minutes, thereby obtaining a coating solution L-16. An easy adhesion-treated surface of PET, in which one surface thereof was subjected to an easy adhesion treatment, was coated with the coating solution L-16 by using a bar coater, followed by drying for 1 hour at room temperature. Thereafter, onto the surface opposite to the coated surface, a pressure sensitive adhesive film (manufactured by PANAC Corporation, GELPOLY (mount type)) was bonded using a laminator, thereby obtaining an antibacterial sheet S-16.

### Example 17

A coating solution L-17 was prepared in the same manner as in Example 16, except that the proportion of the antibacterial agent dispersion added was changed to 0.084 g from 0.0084 g. Furthermore, by using the coating solution L-17, an antibacterial sheet S-17 was obtained in the same manner as in Example 4.

### Example 18

A coating solution L-18 was prepared in the same manner as in Example 16, except that the proportion of the antibacterial agent dispersion added was changed to 0.84 g from 0.0084 g. Furthermore, by using the coating solution L-18, an antibacterial sheet S-18 was obtained in the same manner as in Example 4.

### Example 19

A binder coating solution L-19(b) and a coating solution L-19 were prepared in the same manner as in Example 13, except that, as the silica particles of Example 13, silica particles (mean particle size: 85 nm, concentration of solid contents: 33%) were used instead of the silica particles (“SNOWTEX O-33” manufactured by NISSAN CHEMICAL INDUSTRIES, LTD., mean particle size: 10 to 20 nm, concentration of solid contents: 33%). Furthermore, by using the binder coating solution L-19(b) and the coating solution L-19, an antibacterial sheet S-19(b) and an antibacterial sheet S-19 were obtained in the same manner as in Example 4.

### Example 20

A coating solution L-20 was prepared in the same manner as in Example 14, except that, as the silica particles of Example 14, silica particles (mean particle size: 85 nm, concentration of solid contents: 33%) were used instead of the silica particles (“SNOWTEX O-33” manufactured by NISSAN CHEMICAL INDUSTRIES, LTD., mean particle size: 10 to 20 nm, concentration of solid contents: 33%). Furthermore, by using the coating solution L-20, an antibacterial sheet S-20 was obtained in the same manner as in Example 4.

### Example 21

A coating solution L-21 was prepared in the same manner as in Example 15, except that, as the silica particles of Example 15, silica particles (mean particle size: 85 nm, concentration of solid contents: 33%) were used instead of the silica particles (“SNOWTEX O-33” manufactured by NISSAN CHEMICAL INDUSTRIES, LTD., mean particle size: 10 to 20 nm, concentration of solid contents: 33%). Furthermore, by using the coating solution L-21, an antibacterial sheet S-21 was obtained in the same manner as in Example 4.

### Example 22

A binder coating solution L-22(b) and a coating solution L-22 were prepared in the same manner as in Example 13, except that, as the silica particles of Example 13, silica particles (mean particle size: 120 nm, concentration of solid contents: 33%) were used instead of the silica particles (“SNOWTEX O-33” manufactured by NISSAN CHEMICAL INDUSTRIES, LTD., mean particle size: 10 to 20 nm, concentration of solid contents: 33%). Furthermore, by using the binder coating solution L-22(b) and the coating solution L-22, a sheet S-22(b) and an antibacterial sheet S-22 were obtained in the same manner as in Example 4.

### Example 23

A coating solution L-23 was prepared in the same manner as in Example 14, except that, as the silica particles of Example 14, silica particles (mean particle size: 120 nm, concentration of solid contents: 33%) were used instead of the silica particles (“SNOWTEX O-33” manufactured by NISSAN CHEMICAL INDUSTRIES, LTD., mean particle size: 10 to 20 nm, concentration of solid contents: 33%). Furthermore, by using the coating solution L-23, an antibacterial sheet S-23 was obtained in the same manner as in Example 4.

### Example 24

A coating solution L-24 was prepared in the same manner as in Example 15, except that, as the silica particles of Example 15, silica particles (mean particle size: 120 nm, concentration of solid contents: 33%) were used instead of the silica particles (“SNOWTEX O-33” manufactured by NISSAN CHEMICAL INDUSTRIES, LTD., mean particle size: 10 to 20 nm, concentration of solid contents: 33%). Furthermore, by using the coating solution L-24, an antibacterial sheet S-24 was obtained in the same manner as in Example 15.

### Example 25

A binder coating solution L-25(b) and a coating solution L-25 were prepared in the same manner as in Example 13, except that, in Example 13, an anionic surfactant was not added. Furthermore, by using the binder coating solution L-25(b) and the coating solution L-25, a sheet S-25(b) and an antibacterial sheet S-25 were obtained in the same manner as in Example 4.

### Example 26

A coating solution L-26 was prepared in the same manner as in Example 14, except that, in Example 14, an anionic surfactant was not added. Furthermore, by using the coating solution L-26, an antibacterial sheet S-26 was obtained in the same manner as in Example 4.

### Example 27

A coating solution L-27 was prepared in the same manner as in Example 15, except that, in Example 15, an anionic surfactant was not added. Furthermore, by using the coating solution L-27, an antibacterial sheet S-27 was obtained in the same manner as in Example 4.

### Example 28

A binder coating solution L-28(b) and a coating solution L-28 were prepared in the same manner as in Example 13, except that, in Example 13, a nonionic surfactant and an anionic surfactant were not added. Furthermore, by using the binder coating solution L-28(b) and the coating solution L-28, a sheet S-28(b) and an antibacterial sheet S-28 were obtained in the same manner as in Example 4.

### Example 29

A coating solution L-29 was prepared in the same manner as in Example 14, except that, in Example 14, a nonionic surfactant and an anionic surfactant were not added. Furthermore, by using the coating solution L-29, an antibacterial sheet S-29 was obtained in the same manner as in Example 4.

### Example 30

A coating solution L-30 was prepared in the same manner as in Example 15, except that, in Example 15, a nonionic surfactant and an anionic surfactant were not added. Furthermore, by using the coating solution L-30 an antibacterial sheet S-30 was obtained in the same manner as in Example 4.

### Example 31

A coating solution L-31 was prepared in the same manner as in Example 4, except that, in Example 4, silica particles (“SNOWTEX O-33” manufactured by NISSAN CHEMICAL INDUSTRIES, LTD.) were not added. An easy adhesion-treated surface of PET, in which one surface thereof was subjected to an easy adhesion treatment, was coated with a binder coating solution L-31(b) by using a #50 bar coater, followed by drying for 1 hour at room temperature, thereby obtaining a sheet S-31(b) coated only with a binder.

Furthermore, BACTELITE MP-102SVC13 was added to the binder coating solution L-31(b), at a proportion of 0.0032 g with respect to 100 g of L-31(b), followed by stirring for 15 minutes, thereby obtaining a coating solution L-31. An easy adhesion-treated surface of PET, in which one surface thereof was subjected to an easy adhesion treatment, was coated with the coating solution L-31 by using a #50 bar coater, followed by drying for 1 hour at room temperature. Thereafter, onto the surface opposite to the coated surface, a pressure sensitive adhesive film (manufactured by PANAC Corporation, GELPOLY (mount type)) was bonded using a laminator, thereby obtaining an antibacterial sheet S-31.

### Example 32

A coating solution L-32 was prepared in the same manner as in Example 31, except that, in Example 31, the amount of BACTELITE MP-102SVC13 added was changed to 0.032 g from 0.0032 g. Furthermore, by using the coating solution L-32, an antibacterial sheet S-32 was obtained in the same manner as in Example 4.

### Example 33

A coating solution L-33 was prepared in the same manner as in Example 31, except that, in Example 31, the amount of BACTELITE MP-102SVC13 added was changed to 0.32 g from 0.0032 g. Furthermore, by using the coating solution L-33, an antibacterial sheet S-33 was obtained in the same manner as in Example 4.

### Example 34

A coating solution L-34(b) was prepared in the same manner as in Example 4, except that, in Example 4, the aluminum chelate D (aluminum bisethylacetoacetate•monoacetyl acetonate, concentration of solid contents: 1%) was not added. An easy adhesion-treated surface of PET, in which one surface thereof was subjected to an easy adhesion treatment, was coated with a binder coating solution L-34 by using a #50 bar coater, followed by drying for 1 hour at room temperature, thereby obtaining a sheet S-34(b) coated only with a binder.

Furthermore, BACTELITE MP-102SVC13 was added to the binder coating solution L-34(b), at a proportion of 0.0084 g with respect to 100 g of L-34(b), followed by stirring for 15 minutes, thereby obtaining a coating solution L-34. An easy adhesion-treated surface of PET, in which one surface thereof was subjected to an easy adhesion treatment, was coated with the coating solution L-34 by using a #50 bar coater, followed by drying for 1 hour at room temperature. Thereafter, onto the surface opposite to the coated surface, a pressure sensitive adhesive film (manufactured by PANAC Corporation, GELPOLY (mount type)) was bonded using a laminator, thereby obtaining an antibacterial sheet S-34.

### Example 35

A coating solution L-35 was prepared in the same manner as in Example 34, except that, in Example 34, the amount of BACTELITE MP-102SVC13 added was changed to 0.084 g from 0.0084 g. Furthermore, by using the coating solution L-35, an antibacterial sheet S-35 was obtained in the same manner as in Example 34.

### Example 36

A coating solution L-36 was prepared in the same manner as in Example 34, except that, in Example 34, the amount of BACTELITE MP-102SVC13 added was changed to 0.84 g from 0.0084 g. Furthermore, by using the coating solution L-36, an antibacterial sheet S-36 was obtained in the same manner as in Example 34.

### Example 37

A coating solution L-37(b) was prepared in the same manner as in Example 4, except that, in Example 4, the amount of sodium di(2-ethylhexyl)sulfosuccinate (concentration of solid contents: 0.2%) added was changed to 131.8 g. An easy adhesion-treated surface of PET, in which one surface thereof was subjected to an easy adhesion treatment, was coated with the binder coating solution L-37 by using a #50 bar coater, followed by drying for 1 hour at room temperature, thereby obtaining a sheet S-37(b) coated only with a binder.

Furthermore, BACTELITE MP-102SVC13 was added to the binder coating solution L-37(b), at a proportion of 0.0084 g with respect to 100 g of L-37(b), followed by stirring for 15 minutes, thereby obtaining a coating solution L-37. An easy adhesion-treated surface of PET, in which one surface thereof was subjected to an easy adhesion treatment, was coated with the coating solution L-37 by using a #50 bar coater, followed by drying for 1 hour at room temperature. Thereafter, onto the surface opposite to the coated surface, a pressure sensitive adhesive film (manufactured by PANAC Corporation, GELPOLY (mount type)) was bonded using a laminator, thereby obtaining an antibacterial sheet S-37.

### Example 38

A coating solution L-38 was prepared in the same manner as in Example 37, except that, in Example 37, the amount of BACTELITE MP-102SVC13 added was changed to 0.084 g from 0.0084 g. Furthermore, by using the coating solution L-38, an antibacterial sheet S-38 was obtained in the same manner as in Example 37.

### Example 39

A coating solution L-39 was prepared in the same manner as in Example 37, except that, in Example 37, the amount of BACTELITE MP-102SVC13 added was changed to 0.84 g from 0.0084 g. Furthermore, by using the coating solution L-39, an antibacterial sheet S-39 was obtained in the same manner as in Example 37.

### Example 40

A binder coating solution L-40(b) was prepared in the same manner as in Example 4, except that, in Example 4, a nonionic surfactant (“EMALEX 715” manufactured by NIHON EMULSION Co., Ltd., concentration of solid contents: 0.5%) was not added. An easy adhesion-treated surface of PET, in which one surface thereof was subjected to an easy adhesion treatment, was coated with the binder coating solution L-40(b) by using a #50 bar coater, followed by drying for 1 hour at room temperature, thereby obtaining a sheet S-40(b) coated only with a binder.

Furthermore, BACTELITE MP-102SVC13 was added to the binder coating solution L-40(b), at a proportion of 0.0084 g with respect to 100 g of L-40(b), followed by stirring for 15 minutes, thereby obtaining a coating solution L-40. An easy adhesion-treated surface of PET, in which one surface thereof was subjected to an easy adhesion treatment, was coated with the coating solution L-40 by using a #50 bar coater, followed by drying for 1 hour at room temperature. Thereafter, onto the surface opposite to the coated surface, a pressure sensitive adhesive film (manufactured by PANAC Corporation, GELPOLY (mount type)) was bonded using a laminator, thereby obtaining an antibacterial sheet S-40.

### Example 41

A coating solution L-41 was prepared in the same manner as in Example 40, except that, in Example 40, the amount of BACTELITE MP-102SVC13 added was changed to 0.084 g from 0.0084 g. Furthermore, by using the coating solution L-41, an antibacterial sheet S-41 was obtained in the same manner as in Example 4.

### Example 42

A coating solution L-42 was prepared in the same manner as in Example 40, except that, in Example 40, the amount of BACTELITE MP-102SVC13 added was changed to 0.84 g from 0.0084 g. Furthermore, by using the coating solution L-42, an antibacterial sheet S-42 was obtained in the same manner as in Example 4.

### Example 43

A coating solution L-43 was prepared in the same manner as in Example 17, except that, in Example 17, copper particles (mean particle size: 100 nm) were used instead of silver particles. An easy adhesion-treated surface of PET, in which one surface thereof was subjected to an easy adhesion treatment, was coated with the coating solution L-43 by using a #50 bar coater, followed by drying for 1 hour at room temperature. Thereafter, onto the surface opposite to the coated surface, a pressure sensitive adhesive film (manufactured by PANAC Corporation, GELPOLY (mount type)) was bonded using a laminator, thereby obtaining an antibacterial sheet S-43.

### Example 44

A coating solution L-44 was prepared in the same manner as in Example 4, except that, the amount of BACTELITE MP-102SVC13 added was changed to 0.001 g from 0.0084 g. Furthermore, by using the coating solution L-44, an antibacterial sheet S-44 was obtained in the same manner as in Example 4.

### Example 45

By using the coating solution L-10, an antibacterial sheet S-45 was obtained in the same manner as in Example 10, except that the coating method was changed to applicator coating, in which a clearance was adjusted to become a height of 90 μm, from bar coating.

### Example 46

By using the coating solution L-10, an antibacterial sheet S-46 was obtained in the same manner as in Example 10, except that the #36 bar coater was changed to a #50 bar coater.

### Example 47

By using the coating solution L-4, an antibacterial sheet S-47 was obtained in the same manner as in Example 4, except that the support was changed to TAC from PET.

### Example 48

By using the coating solution L-4, an antibacterial sheet S-48 was obtained in the same manner as in Example 4, except that the support was changed to PC from PET.

### Example 49

A coating solution L-49 was prepared in the same manner as in Example 23, except that the antibacterial agent was changed to BACTEKILLER BM-102SD from BACTELITE MP-102SVC13. Furthermore, by using the coating solution L-49, an antibacterial sheet S-49 was obtained.

### Example 50

A coating solution L-50 was prepared in the same manner as in Example 4, except that the formulation method of the antibacterial agent was changed to the addition of a mixture of 0.0045 g of BACTELITE MP-102SVC13 and 0.0045 g of an antibacterial agent dispersion obtained by dispersing silver particles having a particle size of 0.01 μm in butyl acetate at a concentration of solid contents of 1%. Furthermore, by using the coating solution L-50, an antibacterial sheet S-50 was obtained in the same manner as in Example 4.

### Example 51

(1) Preparation of Reactive Silane Solution

300 g of a 10% isopropanol solution of a siloxane-based binder (“MKC (registered trademark) SILICATE MS51” manufactured by Mitsubishi Chemical Corporation) was added to 1,600 g of a mixture of water and isopropanol (1,000 g of water+600 g of IPA) that was being stirred in a container, and then 100 g of a 10% by weight isopropanol solution of a silane coupling agent was added thereto. Finally, in a state where the resultant was being continuously stirred, 67 g of a 3% by weight methanol solution of aluminum acetyl acetonate was added thereto.

(2) Preparation of Silica Nanoparticles

3-(Trishydroxysilyl)-1-propane sulfonic acid (6.15 g, 32.5% aqueous solution) and isopropanol (56 g) were added to a stirred dispersion of 5 nm silica nanoparticles (NALCO 2326, 50.02 G, solid content: 16.0%). The prepared reaction solution was heated for 5 hours at 50° C., thereby obtaining a dispersion of surface-modified particles having a solid content of 8.5%.

(3) Preparation of Coating Solution and Sheet Sample

The stirred dispersion of the silica nanoparticles was directly added to the reactive silane solution obtained in (1) with stirring, thereby preparing a binder coating solution L-51(b). An easy adhesion-treated surface of PET, in which one surface thereof was subjected to an easy adhesion treatment, was coated with the binder coating solution L-51(b) by using a bar coater, followed by drying for 1 hour at room temperature, thereby obtaining a sheet S-51(b) coated only with a binder.

Furthermore, BACTELITE MP-102SVC13 was added to the binder coating solution L-51(b), at a proportion of 0.0080 g with respect to 100 g of L-51(b), followed by stirring for 15 minutes, thereby obtaining a coating solution L-51. An easy adhesion-treated surface of PET, in which one surface thereof was subjected to an easy adhesion treatment, was coated with the coating solution L-51 by using a bar coater, followed by drying for 1 hour at room temperature. Thereafter, onto the surface opposite to the coated surface, a pressure sensitive adhesive film (manufactured by PANAC Corporation, GELPOLY (mount type)) was bonded using a laminator, thereby obtaining an antibacterial sheet S-51.

### Example 52

A coating solution L-52 was prepared in the same manner as in Example 19, except that the proportion of BACTELITE MP-102SVC13 added was changed to 0.080 g from 0.0080 g. Furthermore, by using the coating solution L-52, an antibacterial sheet S-52 was obtained in the same manner as in Example 4.

### Example 53

A coating solution L-53 was prepared in the same manner as in Example 19, except that the proportion of BACTELITE MP-102SVC13 added was changed to 0.80 g from 0.0080 g. Furthermore, by using the coating solution L-53, an antibacterial sheet S-53 was obtained in the same manner as in Example 10.

### Example 54

Through the two-stage step described below, an antibacterial sheet having two antibacterial layers was prepared.

Coating was performed using the coating solution L-5 of Example 5 by using a #50 bar coater, followed by drying for 1 hour at room temperature. Then, the coated surface was coated with the coating solution L-14 of Example 14 by using a #50 bar coater, followed by drying for 1 hour at room temperature, thereby obtaining an antibacterial sheet S-54.

### Example 55

A transparent PET sheet was spray-coated with the coating solution of Example 5 by using a spray gun, followed by drying for 1 hour at room temperature, thereby obtaining an antibacterial sheet S-55.

### Example 56

A transparent PET sheet was spray-coated with the coating solution of Example 17 by using a spray gun, followed by drying for 1 hour at room temperature, thereby obtaining an antibacterial sheet S-56.

### Example 57

A transparent PET sheet was spray-coated with the coating solution of Example 11 by using a spray gun, followed by drying for 1 hour at room temperature, thereby obtaining an antibacterial sheet S-57.

### Example 58

“BACTELITE MP-102SVC13” which is silver-supporting ceramic manufactured by Fuji Chemical Industry Co., Ltd. (dispersion medium: IPA, concentration of solid contents: 25%) was added to a 100× diluted solution of MPC POLYMER CF72 manufactured by NOF CORPORATION diluted with water, at a proportion of 0.0084 g with respect to 100 g of the diluted solution, followed by stiffing for 15 minutes, thereby obtaining a coating solution L-58. Then, an antibacterial sheet S-58 was obtained by the same method as in Example 1.

### Example 59

0.04 g of a dispersant DISPERBYK 180 was added to 100 g of the binder coating solution L-10(b), thereby obtaining a coating solution L-59. An antibacterial sheet S-59 was obtained in the same manner as in Example 45, except that the coating solution L-59 was used.

### Comparative Example 1

30 parts by mass of anatase-type titanium oxide coated with calcium phosphate supporting silver particles (hydroxyapatite:titanium oxide:silver=15:75:10 (mass ratio)), 60 parts by mass of pentaerythritol acrylate (PETA, manufactured by Nippon Kayaku Co., Ltd., KAYARAD PET-30), 45 parts by mass of photopolymerization initiator (manufactured by Ciba Specialty Chemicals Inc., IRGACURE 181) were mixed together, and then isopropyl alcohol was added thereto, thereby obtaining a coating solution L-X1 with a concentration of solid contents of 25% by mass.

An easy adhesion-treated surface of PET, in which one surface thereof was subjected to an easy adhesion treatment, was coated with a coating solution L-X1 by using a bar coater, followed by curing by ultraviolet ray irradiation. Thereafter, onto the surface opposite to the coated surface, a pressure sensitive adhesive film (manufactured by PANAC Corporation, GELPOLY (mount type)) was bonded using a laminator, thereby obtaining an antibacterial sheet S-X1.

<Various Evaluations>

(Water contact angle of only binder and antibacterial layer) The water contact angle of only the binder was measured for the aforementioned S-1(b), S-4(b), S-10(b), S-19(b), S-22(b), S-25(b), S-28(b), S-31(b), S-34(b), S-37(b), S-40(b), and S-51(b). Regarding Examples 58 and 59 and Comparative Example 1, the water contact angle of only the binder was measured.

The water contact angle of the antibacterial layer was measured for the aforementioned antibacterial sheets S-1 to S-59 and S-X1. As a method for measuring the water contact angle, a sessile drop method of JIS R 3257:1999 was used. For measuring the water contact angle, LSE-ME1 (software 2win mini) manufactured by NiCK Corporation was used. More specifically, at room temperature (20° C.), 2 μl of droplets of pure water were added dropwise onto a surface of the antibacterial layer as a measurement subject which was kept horizontal, and a contact angle at a point in time when 20 seconds has elapsed from the dropping was measured.

The results are summarized in Table 1.

The water contact angle of only the binder described in Table 1 was obtained by evaluating the antibacterial sheet obtained in each example and comparative example, which will be described later, from which the antibacterial agent was excluded.

(Antifogging Properties)

The antifogging properties of the antibacterial sheets obtained in examples and comparative examples were evaluated by the following method. At a temperature of 23° C. and a humidity of 50%, the antibacterial sheet was bonded to the outside of a glass container. Five minutes after ice water was put into the glass container, to what degree the container was prevented from becoming cloudy due to the antibacterial sheet bonded thereto was visually observed as sensory evaluation.

In the sensory evaluation, a case where cloudiness was not observed was evaluated to be A, a case where the glass container was found to be slightly cloudy but the cloudiness did not affect at all the visibility of the inside of the glass container was evaluated to be B, and a case where the glass container was cloudy, the visibility of the inside of the glass container was poor, and it was difficult to observe the inside of the glass container was evaluated to be C.

The results are summarized in Table 1.

(Antibacterial Properties)

According to the evaluation method described in JIS Z 2801, a level of antibacterial activity exhibited 3 hours after a bacterial solution contacted each antibacterial sheet was measured, and the antibacterial properties were evaluated according to the following standards. The higher the level of antibacterial activity, the higher the antibacterial properties. An antibacterial sheet having a level of antibacterial activity of less than 1.0 was evaluated to be D corresponding to “insufficient antibacterial properties”, an antibacterial sheet having a level of antibacterial activity of equal to or higher than 1.0 and lower than 1.5 was evaluated to be C corresponding to “improvement of antibacterial properties”, an antibacterial sheet having a level of antibacterial activity of equal to or higher than 1.5 and lower than 3.0 was evaluated to be B corresponding to “sufficient antibacterial properties”, and an antibacterial sheet having a level of antibacterial activity of equal to or higher than 3.0 was evaluated to be A corresponding to “particularly excellent antibacterial properties”. E. coli was used as a bacterial species.

The results are summarized in Table 1.

(Haze)

A surface of the antibacterial sheet that was on the pressure sensitive layer side was bonded to a glass substrate, and a haze was measured based on JIS K7361.

The results are summarized in Table 1.

Particularly, for the use that requires transparency, an antibacterial sheet having a small haze can be used.

(Root Mean Square Roughness)

The root mean square roughness of the surface of the antibacterial layer was determined based on JIS B 0601.

The results are summarized in Table 1.

(Surface Electrical Resistance)

The surface electrical resistance of the surface of the antibacterial layer was measured in an environment with a temperature of 25° C. and a relative humidity or 60% RH. By using a device, which was obtained by connecting a resistivity chamber R12704A (manufactured by ADVANTEST CORPORATION) to a digital electrometer R8252 (manufactured by ADVANTEST CORPORATION), as a measurement device, a surface resistivity was measured based on JIS K 6911. The unit thereof was Ω/square (=Ω/sq). The results are summarized in Table 1.

(Scratch Resistance Test)

The scratch resistance was measured by the method described below. That is, an antibacterial sheet to be measured was brought into contact with #0000 steel wool at an area of 25 mmφ under a load of 50 g, and moved a distance of 5 cm back and forth ten times at a rate of 1 m/min, and whether the contact portion was scratched was visually observed. An antibacterial sheet found not to have a scratch at all was evaluated to e A, an antibacterial sheet found to be slightly scratched was evaluated to be B, and an antibacterial sheet severely scratched or peeled was evaluated to be C. The results are summarized in Table 1.

(Dust Protection Properties)

The dust protection properties of the antibacterial sheets obtained in examples and comparative examples were evaluated by the following method. A certain amount of cedar pollen was scattered on an antibacterial sheet to be measured, and the antibacterial sheet was tilted by 45°. Then a strong impact was applied to the antibacterial sheet, and at this time, the way the cedar pollen that adhered to the antibacterial layer fell was visually observed as sensory evaluation. An antibacterial sheet from which the cedar pollen cleanly fell was evaluated to be A, an antibacterial sheet in which the cedar pollen slightly remained was evaluated to be B, and an antibacterial sheet practically did not show a change was evaluated to be C. The results are summarized in Table 1.

(Elution Test (Amount of Eluted Ag⁺)

By using the antibacterial sheets obtained in the respective examples and comparative examples, the extraction test described above was performed. The unit of the column of “Amount of eluted Ag⁺” in Table 1 which will be described later is ng/cm².

In Table 1, “Ratio of solid content of binder coating solution (wt %)” shows a ratio of solid content in a binder coating solution.

In Table 1, “Ratio of water in coating solution (wt %)” shows a content of water in a binder coating solution.

In Table 1, 1*10̂9″ or the like in the column of “Surface electrical resistance” means “1*10⁹”.

The value of haze of the antibacterial layer (antibacterial coat) is a value obtained by subtracting a value of haze of the support from a value of haze of the antibacterial sheet including the support and the antibacterial layer. The value of haze of the antibacterial layer of each example was equal to or less than the value of haze of the antibacterial sheet of each example.

TABLE 1

| | | | Ratio of | | | | | | |
|---|---|---|---|---|---|---|---|---|---|
| | | | solid | Water | | | Ratio | | |
| | | | content | contact | | | of | | |
| | | | of | angle of | | | water | | Thickness |
| | | | binder | only | | | in | | of |
| | | | coating | binder | | | coating | | antibacterial |
| Table | Silica fine | | solution | (20 | Antibacterial | | solution | | layer |
| 1-1 | particles | | (wt %) | seconds) | agent | Surfactant | (wt %) | Support | (μm) |
| Example 1 | 10 to 15 | nm | 2.1% | 15° | Silver- | Nonionic | 57% | PET | 0.15 |
| Example 2 | 10 to 15 | nm | 2.1% | | supporting | [polyethylene | 57% | PET | 0.15 |
| Example 3 | 10 to 15 | nm | 2.1% | | ceramic | glycol | 57% | PET | 0.15 |
| | | | | | MP-102SVC | monolauryl | | | |
| | | | | | 13 | ether] + anionic | | | |
| | | | | | | [sodium(2-ethyl | | | |
| | | | | | | hexyl)sulfosuccinate] | | | |
| Example 4 | 10 to 20 | nm | 2.1% | 8° | Silver- | Nonionic | 50% | PET | 0.13 |
| Example 5 | 10 to 20 | nm | 2.1% | | supporting | [EMALEX 715] + | 50% | PET | 0.13 |
| Example 6 | 10 to 20 | nm | 2.1% | | ceramic | anionic | 50% | PET | 0.13 |
| | | | | | MP-102SVC | [sodium(2-ethyl | | | |
| | | | | | 13 | hexyl)sulfosuccinate] | | | |
| Example 7 | 10 to 20 | nm | 2.1% | 8° | Silver- | Nonionic | 50% | PET | 0.8 |
| Example 8 | 10 to 20 | nm | 2.1% | | supporting | [EMALEX 715] + | 50% | PET | 0.8 |
| Example 9 | 10 to 20 | nm | 2.1% | | ceramic | anionic | 50% | PET | 0.8 |
| | | | | | MP-102SVC | [sodium(2-ethyl | | | |
| | | | | | 13 | hexyl)sulfosuccinate] | | | |
| Example | 10 to 20 | nm | 10.4% | 8° | Silver- | Nonionic | 17% | PET | 3.0 |
| 10 | | | | | supporting | [EMALEX 715] + | | | |
| Example | 10 to 20 | nm | 10.4% | | ceramic | anionic | 17% | PET | 3.0 |
| 11 | | | | | MP-102SVC | [sodium(2-ethyl | | | |
| Example | 10 to 20 | nm | 10.4% | | 13 | hexyl)sulfosuccinate] | 17% | PET | 3.0 |
| 12 | | | | | | | | | |
| Example | 10 to 20 | nm | 2.1% | 8° | Silver- | Nonionic | 50% | PET | 0.8 |
| 13 | | | | | supporting | [EMALEX 715] + | | | |
| Example | 10 to 20 | nm | 2.1% | | ceramic | anionic | 50% | PET | 0.8 |
| 14 | | | | | BM-103CI- | [sodium(2-ethyl | | | |
| Example | 10 to 20 | nm | 2.1% | | Z/IPA | hexyl)sulfosuccinate] | 50% | PET | 0.8 |
| 15 | | | | | | | | | |
| Example | 10 to 20 | nm | 2.1% | 8° | Silver | Nonionic | 50% | PET | 0.8 |
| 16 | | | | | particles/butyl | [EMALEX 715] + | | | |
| Example | 10 to 20 | nm | 2.1% | | acetate | anionic | 50% | PET | 0.8 |
| 17 | | | | | | [sodium(2-ethyl | | | |
| Example | 10 to 20 | nm | 2.1% | | | hexyl)sulfosuccinate] | 50% | PET | 0.8 |
| 18 | | | | | | | | | |
| Example | 85 | nm | 2.1% | 8° | Silver- | Nonionic | 50% | PET | 0.8 |
| 19 | | | | | supporting | [EMALEX 715] + | | | |
| Example | 85 | nm | 2.1% | | ceramic | anionic | 50% | PET | 0.8 |
| 20 | | | | | BM-103CI- | [sodium(2-ethyl | | | |
| Example | 85 | nm | 2.1% | | Z/IPA | hexyl)sulfosuccinate] | 50% | PET | 0.8 |
| 21 | | | | | | | | | |
| Example | 120 | nm | 2.1% | 8° | Silver- | Nonionic | 50% | PET | 0.8 |
| 22 | | | | | supporting | [EMALEX 715] + | | | |
| Example | 120 | nm | 2.1% | | ceramic | anionic | 50% | PET | 0.8 |
| 23 | | | | | BM-103CI- | [sodium(2-ethyl | | | |
| Example | 120 | nm | 2.1% | | Z/IPA | hexyl)sulfosuccinate] | 50% | PET | 0.8 |
| 24 | | | | | | | | | |
| Example | 10 to 20 | nm | 2.1% | 8° | Silver- | Nonionic | 51% | PET | 0.8 |
| 25 | | | | | supporting | [EMALEX 715] | | | |
| Example | 10 to 20 | nm | 2.1% | | ceramic | | 51% | PET | 0.8 |
| 26 | | | | | BM-103CI- | | | | |
| Example | 10 to 20 | nm | 2.1% | | Z/IPA | | 51% | PET | 0.8 |
| 27 | | | | | | | | | |
| Example | 10 to 20 | nm | 2.2% | 8° | Silver- | N/A | 54% | PET | 0.8 |
| 28 | | | | | supporting | | | | |
| Example | 10 to 20 | nm | 2.2% | | ceramic | | 54% | PET | 0.8 |
| 29 | | | | | BM-103CI- | | | | |
| Example | 10 to 20 | nm | 2.2% | | Z/IPA | | 54% | PET | 0.8 |
| 30 | | | | | | | | | |

| | | | | | | | | |
|---|---|---|---|---|---|---|---|---|
| Example | — | 0.8% | 10° | Silver- | Nonionic | 52% | PET | 0.3 |
| 31 | | | | supporting | [EMALEX 715] + | | | |
| Example | — | 0.8% | | ceramic | anionic | 52% | PET | 0.3 |
| 32 | | | | MP-102SVC | [sodium(2-ethyl | | | |
| Example | — | 0.8% | | 13 | hexyl)sulfosuccinate] | 52% | PET | 0.3 |
| 33 | | | | | | | | |

| | Water | | | | | | | | Dust |
|---|---|---|---|---|---|---|---|---|---|
| | contact | | | Root | | | | | protection |
| | angle | | | mean | Surface | | | Antibacterial | properties |
| | of | Amount | | square | electrical | | | properties | (cedar |
| Table | antibacterial | of eluted | | roughness | resistance | Scratch | Antifogging | (Based | pollen |
| 1-1 | layer | Ag⁺ | Haze | (μm) | (Ω/square) | resistance | properties | on JIS) | test) |
| Example 1 | 15° | 0.2 | 1.2 | 0.009 | 1 * 10⁹ | A | B | B | A |
| Example 2 | 16° | 2 | 1.5 | 0.012 | 8 * 10⁸ | A | B | B | A |
| Example 3 | 20° | 10 | 2.0 | 0.015 | 5 * 10⁸ | A | B | A | A |
| Example 4 | 8° | 0.2 | 0.9 | 0.008 | 5 * 10⁸ | A | A | B | A |
| Example 5 | 8° | 1.8 | 1.0 | 0.01 | 3 * 10⁸ | A | A | B | A |
| Example 6 | 9° | 18 | 1.2 | 0.012 | 8 * 10⁷ | A | A | A | A |
| Example 7 | 8° | 1.0 | 2.0 | 0.05 | 2 * 10⁸ | A | A | B | A |
| Example 8 | 8° | 15 | 2.2 | 0.08 | 1 * 10⁸ | A | A | A | A |
| Example 9 | 9° | 20 | 2.5 | 0.1 | 4 * 10⁷ | A | A | A | A |
| Example | 8° | 5 | 2.2 | 0.05 | 1 * 10⁸ | A | A | B | A |
| 10 | | | | | | | | | |
| Example | 8° | 15 | 2.5 | 0.08 | 3 * 10⁷ | A | A | A | A |
| 11 | | | | | | | | | |
| Example | 9° | 20 | 2.6 | 0.1 | 1 * 10⁷ | A | A | A | A |
| 12 | | | | | | | | | |
| Example | 8° | 1.2 | 0.9 | 0.02 | 2 * 10⁸ | A | A | B | A |
| 13 | | | | | | | | | |
| Example | 8° | 15 | 1.0 | 0.03 | 1 * 10⁸ | A | A | B | A |
| 14 | | | | | | | | | |
| Example | 8° | 20 | 1.2 | 0.05 | 4 * 10⁷ | A | A | A | A |
| 15 | | | | | | | | | |
| Example | 8° | 3 | 0.9 | 0.008 | 1 * 10⁸ | A | A | B | A |
| 16 | | | | | | | | | |
| Example | 8° | 30 | 1.0 | 0.01 | 3 * 10⁷ | A | A | B | A |
| 17 | | | | | | | | | |
| Example | 9° | 100 | 1.2 | 0.012 | 1 * 10⁷ | A | A | A | A |
| 18 | | | | | | | | | |
| Example | 8° | 1.2 | 5 | 0.3 | 2 * 10⁸ | A | A | B | A |
| 19 | | | | | | | | | |
| Example | 8° | 15 | 6 | 0.3 | 1 * 10⁸ | A | A | B | A |
| 20 | | | | | | | | | |
| Example | 8° | 20 | 7 | 0.3 | 4 * 10⁷ | A | A | A | A |
| 21 | | | | | | | | | |
| Example | 8° | 1.2 | 7 | 0.5 | 2 * 10⁸ | A | A | B | A |
| 22 | | | | | | | | | |
| Example | 8° | 15 | 9 | 0.5 | 1 * 10⁸ | A | A | B | A |
| 23 | | | | | | | | | |
| Example | 8° | 20 | 11 | 0.5 | 4 * 10⁷ | A | A | A | A |
| 24 | | | | | | | | | |
| Example | 8° | 1.0 | 0.9 | 0.1 | 2 * 10⁹ | A | A | B | B |
| 25 | | | | | | | | | |
| Example | 8° | 15 | 1.0 | 0.2 | 1 * 10⁹ | A | A | B | B |
| 26 | | | | | | | | | |
| Example | 9° | 20 | 1.2 | 0.3 | 4 * 10⁸ | A | A | A | B |
| 27 | | | | | | | | | |
| Example | 8° | 1.0 | 0.9 | 0.3 | 2 * 10⁹ | A | A | B | C |
| 28 | | | | | | | | | |
| Example | 8° | 15 | 1.0 | 0.4 | 1 * 10⁹ | A | A | B | C |
| 29 | | | | | | | | | |
| Example | 9° | 20 | 1.2 | 0.5 | 4 * 10⁸ | A | A | A | C |
| 30 | | | | | | | | | |
| Example | 10° | 0.2 | 0.9 | 0.008 | 4 * 10⁸ | C | A | B | A |
| 31 | | | | | | | | | |
| Example | 10° | 1.8 | 1.0 | 0.01 | 2 * 10⁸ | C | A | B | A |
| 32 | | | | | | | | | |
| Example | 11° | 18 | 1.2 | 0.012 | 6 * 10⁷ | C | B | A | A |
| 33 | | | | | | | | | |

TABLE 2

| | | Ratio of | Water | | | Ratio of | | | Water |
|---|---|---|---|---|---|---|---|---|---|
| | | solid content | contact | | | water in | | Thickness | contact |
| | | of binder coating | angle of | | | coating | | of antibac- | angle of |
| Table | Silica fine | solution | only binder | Antibacterial | | solution | Sup- | terial layer | antibac- |
| 1-2 | particles | (wt %) | (20 seconds) | agent | Surfactant | (wt %) | port | (μm) | terial layer |
| Exam- | 10 to 20 nm | 2.1% | 10° | Silver- | Nonionic | 51% | PET | 0.8 | 10° |
| ple 34 | | | | supporting | [EMALEX 715] + | | | | |
| Exam- | 10 to 20 nm | 2.1% | | ceramic | anionic | 51% | PET | 0.8 | 10° |
| ple 35 | | | | MP-102SVC | [sodium(2-ethyl | | | | |
| Exam- | 10 to 20 nm | 2.1% | | 13 | hexyl)sulfosucci- | 51% | PET | 0.8 | 11° |
| ple 36 | | | | | nate] | | | | |
| Exam- | 10 to 20 nm | 1.9% | 10° | Silver- | Nonionic | 45% | PET | 0.8 | 10° |
| ple 37 | | | | supporting | [EMALEX 715] + | | | | |
| Exam- | 10 to 20 nm | 1.9% | | ceramic | anionic | 45% | PET | 0.8 | 10° |
| ple 38 | | | | MP-102SVC | [sodium(2-ethyl | | | | |
| Exam- | 10 to 20 nm | 1.9% | | 13 | hexyl)sulfosucci- | 44% | PET | 0.8 | 11° |
| ple 39 | | | | | nate] | | | | |
| Exam- | 10 to 20 nm | 2.2% | 10° | Silver- | Anionic | 53% | PET | 0.8 | 10° |
| ple 40 | | | | supporting | [sodium(2-ethyl | | | | |
| Exam- | 10 to 20 nm | 2.2% | | ceramic | hexyl)sulfosucci- | 53% | PET | 0.8 | 10° |
| ple 41 | | | | MP-102SVC | nate] | | | | |
| Exam- | 10 to 20 nm | 2.2% | | 13 | | 52% | PET | 0.8 | 11° |
| ple 42 | | | | | | | | | |
| Exam- | 10 to 20 nm | 2.1% | 8° | Silver | Nonionic | 50% | PET | 0.8 | 10° |
| ple 43 | | | | particles/ | [EMALEX 715] + | | | | |
| | | | | butyl | anionic | | | | |
| | | | | acetate | [sodium(2-ethyl | | | | |
| | | | | | hexyl)sulfosucci- | | | | |
| | | | | | nate] | | | | |
| Exam- | 10 to 20 nm | 2.1% | 8° | Silver- | Nonionic | 50% | PET | 0.13 | 7° |
| ple 44 | | | | supporting | [EMALEX 715] + | | | | |
| | | | | ceramic | anionic | | | | |
| | | | | MP-102SVC | [sodium(2-ethyl | | | | |
| | | | | 13 | hexyl)sulfosucci- | | | | |
| | | | | | nate] | | | | |
| Exam- | 10 to 20 nm | 10.4% | 8° | Silver- | Nonionic | 17% | PET | 10 | 8° |
| ple 45 | | | | supporting | [EMALEX 715] + | | | | |
| | | | | ceramic | anionic | | | | |
| | | | | MP-102SVC | [sodium(2-ethyl | | | | |
| | | | | 13 | hexyl)sulfosucci- | | | | |
| | | | | | nate] | | | | |
| Exam- | 10 to 20 nm | 10.4% | 8° | Silver- | Nonionic | 17% | PET | 5.0 | 8° |
| ple 46 | | | | supporting | [EMALEX 715] + | | | | |
| | | | | ceramic | anionic | | | | |
| | | | | MP-102SVC | [sodium(2-ethyl | | | | |
| | | | | 13 | hexyl)sulfosucci- | | | | |
| | | | | | nate] | | | | |
| Exam- | 10 to 20 nm | 2.1% | 8° | Silver- | Nonionic | 50% | TAC | 0.13 | 8° |
| ple 47 | | | | supporting | [EMALEX 715] + | | | | |
| | | | | ceramic | anionic | | | | |
| | | | | MP-102SVC | [sodium(2-ethyl | | | | |
| | | | | 13 | hexyl)sulfosucci- | | | | |
| | | | | | nate] | | | | |
| Exam- | 10 to 20 nm | 2.1% | 8° | Silver- | Nonionic | 50% | PC | 0.13 | 8° |
| ple 48 | | | | supporting | [EMALEX 715] + | | | | |
| | | | | ceramic | anionic | | | | |
| | | | | MP-102SVC | [sodium(2-ethyl | | | | |
| | | | | 13 | hexyl)sulfosucci- | | | | |
| | | | | | nate] | | | | |
| Exam- | 120 nm | 2.1% | 8° | Silver- | Nonionic | 50% | PET | 10 | 10° |
| ple 49 | | | | supporting | [EMALEX 715] + | | | | |
| | | | | ceramic | anionic | | | | |
| | | | | BM-102SD | [sodium(2-ethyl | | | | |
| | | | | | hexyl)sulfosucci- | | | | |
| | | | | | nate] | | | | |
| Exam- | 10 to 20 nm | 2.1% | 8° | Silver- | Nonionic | 50% | PET | 0.13 | 8° |
| ple 50 | | | | supporting | [EMALEX 715] + | | | | |
| | | | | ceramic | anionic | | | | |
| | | | | MP-102SVC | [sodium(2-ethyl | | | | |
| | | | | 13 + silver | hexyl)sulfosucci- | | | | |
| | | | | particles/ | nate] | | | | |
| | | | | butyl | | | | | |
| | | | | acetate | | | | | |
| | | | | (50%/50%) | | | | | |

| | | | | | | | Antibac- | Dust |
|---|---|---|---|---|---|---|---|---|
| | | | Root mean | Surface | | | terial | protection |
| | Amount | | square | electrical | | Anti- | properties | properties |
| Table | of eluted | | roughness | resistance | Scratch | fogging | (Based | (cedar pollen |
| 1-2 | Ag⁺ | Haze | (μm) | (Ω/square) | resistance | properties | on JIS) | test) |
| Exam- | 0.2 | 0.9 | 0.008 | 4*10⁸ | C | A | B | A |
| ple 34 | | | | | | | | |
| Exam- | 1.8 | 1.0 | 0.01 | 2*10⁸ | C | A | B | A |
| ple 35 | | | | | | | | |
| Exam- | 18 | 1.2 | 0.012 | 6*10⁷ | C | B | A | A |
| ple 36 | | | | | | | | |
| Exam- | 0.2 | 0.9 | 0.008 | 4*10⁸ | A | A | B | A |
| pl 37 | | | | | | | | |
| Exam- | 1.8 | 1.0 | 0.01 | 2*10⁸ | A | A | B | A |
| ple 38 | | | | | | | | |
| Exam- | 18 | 1.2 | 0.012 | 6*10⁷ | A | B | A | A |
| ple 39 | | | | | | | | |
| Exam- | 0.2 | 0.9 | 0.008 | 4*10⁸ | A | A | B | A |
| ple 40 | | | | | | | | |
| Exam- | 1.8 | 1.0 | 0.01 | 2*10⁸ | A | A | B | A |
| ple 41 | | | | | | | | |
| Exam- | 18 | 1.2 | 0.012 | 6*10⁷ | A | B | A | A |
| ple 42 | | | | | | | | |
| Exam- | — | 1.0 | 0.01 | 2*10⁹ | A | A | C | A |
| ple 43 | | | | | | | | |
| Exam- | 0.03 | 0.7 | 0.005 | 1.2*10¹⁰ | A | A | C | A |
| ple 44 | | | | | | | | |
| Exam- | 5 | 2.2 | 0.05 | 5.0*10⁹ | C | A | A | A |
| ple 45 | | | | | | | | |
| Exam- | 5 | 2.2 | 0.05 | 5.0*10⁹ | B | A | A | A |
| ple 46 | | | | | | | | |
| Exam- | 0.2 | 0.9 | 0.008 | 5.0*10⁹ | B | A | B | A |
| ple 47 | | | | | | | | |
| Exam- | 0.2 | 0.9 | 0.008 | 5.0*10⁹ | B | A | B | A |
| ple 48 | | | | | | | | |
| Exam- | 5 | 5.0 | 2.2 | 5.0*10⁹ | C | A | B | A |
| ple 49 | | | | | | | | |
| Exam- | 0.2 | 0.9 | 0.008 | 5.0*10⁹ | A | A | A | A |
| ple 50 | | | | | | | | |

TABLE 3

| | | Ratio of | | | | | | | |
|---|---|---|---|---|---|---|---|---|---|
| | | solid content | Water | | | Ratio of | | | Water |
| | | of binder | contact | | | water in | | Thickness | contact |
| | | coating | angle of | | | coating | | of antibac- | angle of |
| Table | Silica fine | solution | only binder | Antibacterial | | solution | Sup- | terial layer | antibac- |
| 1-3 | particles | (wt %) | (20 seconds) | agent | Surfactant | (wt %) | port | (μm) | terial layer |
| Exam- | 5 nm | 2.4% | 5° | Silver- | N/A | 46% | PET | 0.9 | 6° |
| ple 51 | | | | supporting | | | | | |
| Exam- | 5 nm | 2.4% | | ceramic | | 46% | PET | 0.9 | 6° |
| ple 52 | | | | MP-102SVC | | | | | |
| Exam- | 5 nm | 2.4% | | 13 | | 46% | PET | 0.9 | 7° |
| ple 53 | | | | | | | | | |
| Exam- | 10 to 20 nm | 2.1% | 8° | Lower layer | Nonionic | 50% | PET | Lower | 8° |
| ple 54 | | | | MP-102SVC | [EMALEX 715] + | | | layer 0.8 + | |
| | | | | 13 + upper | anionic | | | upper | |
| | | | | layer | [sodium(2-ethyl | | | layer 0.8 | |
| | | | | BM-103CI- | hexyl)sulfosucci- | | | | |
| | | | | Z/IPA | nate] | | | | |
| Exam- | 10 to 20 nm | 2.1% | 8° | Silver- | Nonionic | 50% | PET | 0.5 | 8° |
| ple 55 | | | | supporting | [EMALEX 715] + | | | | |
| | | | | ceramic | anionic | | | | |
| | | | | MP-102SVC | [sodium(2-ethyl | | | | |
| | | | | 13 | hexyl)sulfosucci- | | | | |
| | | | | | nate] | | | | |
| Exam- | 10 to 20 nm | 2.1% | 8° | Silver | Nonionic | 50% | PET | 0.5 | 8° |
| ple 56 | | | | particles/ | [EMALEX 715] + | | | | |
| | | | | butyl | anionic | | | | |
| | | | | acetate | [sodium(2-ethyl | | | | |
| | | | | | hexyl)sulfosucci- | | | | |
| | | | | | nate] | | | | |
| Exam- | 10 to 20 nm | 10.4% | 15° | Silver- | Nonionic | 17% | PET | 3 | 8° |
| ple 57 | | | | supporting | [EMALEX 715] + | | | | |
| | | | | ceramic | anionic | | | | |
| | | | | MP-102SVC | [sodium(2-ethyl | | | | |
| | | | | 13 | hexyl)sulfosucci- | | | | |
| | | | | | nate] | | | | |
| Exam- | — | 10.0% | 15° | Silver- | — | 90% | PET | 0.15 | 20° |
| ple 58 | | | | supporting | | | | | |
| | | | | ceramic | | | | | |
| | | | | MP-102SVC | | | | | |
| | | | | 13 | | | | | |
| Exam- | 10 to 20 nm | 10.4% | 9° | Silver- | Nonionic | 17% | PET | 10 | 8° |
| ple 59 | | | | supporting | [EMALEX 715] + | | | | |
| | | | | ceramic | anionic | | | | |
| | | | | MP-102SVC | [sodium(2-ethyl | | | | |
| | | | | 13 | hexyl)sulfosucci- | | | | |
| | | | | | nate] | | | | |
| Com- | — | 19.4% | 30° | Ag + | — | 0% | PET | 1.0 | 30° |
| parative | | | | photocatalyst | | | | | |
| Exam- | | | | (TiO₂) | | | | | |
| ple 1 | | | | | | | | | |

| | | | | | | | Antibac- | Dust |
|---|---|---|---|---|---|---|---|---|
| | | | Root mean | Surface | | | terial | protection |
| | Amount | | square | electrical | | Anti- | properties | properties |
| Table | of eluted | | roughness | resistance | Scratch | fogging | (Based | (cedar pollen |
| 1-3 | Ag⁺ | Haze | (μm) | (Ω/square) | resistance | properties | on JIS) | test) |
| Exam- | 1.0 | 2.0 | 0.03 | 1*10⁹ | A | A | B | C |
| ple 51 | | | | | | | | |
| Exam- | 15 | 3.0 | 0.05 | 8*10⁸ | A | A | B | C |
| ple 52 | | | | | | | | |
| Exam- | 20 | 4.0 | 0.07 | 5*10⁸ | A | A | A | C |
| ple 53 | | | | | | | | |
| Exam- | 15 | 1.0 | 0.03 | 3*10⁹ | A | A | B | A |
| ple 54 | | | | | | | | |
| Exam- | 20 | 20 | 2 | 5*10⁸ | A | A | A | A |
| ple 55 | | | | | | | | |
| Exam- | 20 | 20 | 2 | 5*10⁸ | A | A | A | A |
| ple 56 | | | | | | | | |
| Exam- | 15 | 20 | 2 | 3*10⁷ | A | A | A | A |
| ple 57 | | | | | | | | |
| Exam- | 0.2 | 1.2 | 0.009 | 1*10⁹ | C | B | B | C |
| ple 58 | | | | | | | | |
| Exam- | 5 | 2.2 | 0.05 | 5.0*10⁹ | B | A | A | A |
| ple 59 | | | | | | | | |
| Com- | 10 | 2.0 | 0.11 | 8*10⁹ | C | C | D | C |
| parative | | | | | | | | |
| Exam- | | | | | | | | |
| ple 1 | | | | | | | | |

As shown in Table 1, it was confirmed that the antibacterial sheet of the present invention exhibits desired effects.

Particularly, through the comparison of Examples 1 to 3 and Comparative Examples 4 to 6, it was confirmed that, in a case where a water contact angle of only the binder is equal to or less than 10°, antifogging properties are further improved.

Through the comparison of Examples 13 to 15 and 25 to 30, it was confirmed that, in a case where a surfactant is used, dust protection properties are further improved, and particularly in a case where a nonionic surfactant and an ionic surfactant (particularly an anionic surfactant) are used in combination, the effects are further improved.

Through the comparison of Examples 4 to 6 and Examples 31 to 33, it was confirmed that the use of silica particles further improves scratch resistance.

Through the comparison of Examples 4 to 6 and Examples 34 to 36, it was confirmed that the use of a catalyst further improves scratch resistance.

Through the comparison of Examples 5 and 55, it was confirmed that, in a case where spray coating is performed, antibacterial properties of the antibacterial layer are further improved.

### EXPLANATION OF REFERENCES

142 support
144 antibacterial layer
146 pressure sensitive adhesive layer
148 release sheet

What is claimed is:

1. An antibacterial sheet comprising;
a support; and
at least one antibacterial layer disposed on the support,
wherein the antibacterial layer contains a binder and an antibacterial agent, and
a water contact angle of only the binder is equal to or less than 20°.

2. The antibacterial sheet according to claim 1,
wherein the water contact angle of only the binder is equal to or less than 10°.

3. The antibacterial sheet according to claim 1,
wherein the binder contains at least one kind of siloxane compound.

4. The antibacterial sheet according to claim 1,
wherein the antibacterial layer is a layer formed using a coating solution containing a siloxane oligomer represented by the following Formula (1) and an antibacterial agent, 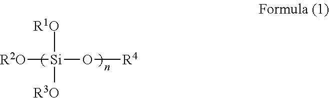
in Formula (1), R¹ to R⁴ each independently represent an organic group having 1 to 6 carbon atoms, and n represents an integer of 2 to 20.

5. The antibacterial sheet according to claim 4,
wherein the antibacterial layer contains a catalyst accelerating condensation of the siloxane oligomer.

6. The antibacterial sheet according to claim 1,
wherein the antibacterial layer further contains at least one kind of silica particles.

7. The antibacterial sheet according to claim 6,
wherein the silica particles contain silica particles having a mean particle size of equal to or less than 100 nm.

8. The antibacterial sheet according to claim 6,
wherein the silica particles contain silica particles having a mean particle size of equal to or less than 20 nm.

9. The antibacterial sheet according to claim 1,
wherein the antibacterial layer further contains at least one kind of surfactant.

10. The antibacterial sheet according to claim 9,
wherein the surfactant contains at least one kind of ionic surfactant.

11. The antibacterial sheet according to claim 4,
wherein the coating solution contains an ionic surfactant, and
a content of the ionic surfactant is equal to or less than 1.0% by mass with respect to a total mass of the coating solution.

12. The antibacterial sheet according to claim 9,
wherein the surfactant contains at least one kind of nonionic surfactant.

13. The antibacterial sheet according to claim 1,
wherein the antibacterial layer further contains an antistatic agent.

14. The antibacterial sheet according to claim 1,
wherein the antibacterial agent contains silver or silver-supporting ceramic.

15. The antibacterial sheet according to claim 1,
wherein the antibacterial agent contains silver-supporting glass.

16. The antibacterial sheet according to claim 1,
wherein a water contact angle of a surface of the antibacterial layer is equal to or less than 20°.

17. The antibacterial sheet according to claim 1,
wherein the water contact angle of the surface of the antibacterial layer s equal to or less than 10°.

18. The antibacterial sheet according to claim 1,
wherein an amount of silver ions, measured by the following extraction test, per unit area of the antibacterial layer is equal to or greater than 15 ng/cm²,
in the extraction test, a 1/500 normal nutrient broth medium specified in JIS Z 2801:2010 is used as an extractant; the temperature of the extractant is controlled within a range of 35±1° C.; the extractant is brought into contact with the surface of the antibacterial layer for 1 hour; the amount of silver ions extracted into the extractant is measured; the obtained value is divided by a contact area between the surface of the antibacterial layer and the extractant so as to obtain the amount of silver ions per unit area; a unit of the amount of silver ions is ng; a unit of the contact area is cm²; and a unit of the amount of silver ions per unit area is ng/cm².

19. The antibacterial sheet according to claim 1 that has a haze of equal to or less than 10%.

20. The antibacterial sheet according to claim 1 that has a haze of equal to or less than 3%.

21. The antibacterial sheet according to claim 1 that has a haze of equal to or less than 1%.

22. The antibacterial sheet according to claim 1,
wherein a root mean square roughness of the surface of the antibacterial layer is equal to or less than 0.1 μm.

23. The antibacterial sheet according to claim 1,
wherein the root mean square roughness of the surface of the antibacterial layer is equal to or less than 0.05 μm.

24. The antibacterial sheet according to claim 1,
wherein the root mean square roughness of the surface of the antibacterial layer is equal to or less than 0.01 μm.

25. The antibacterial sheet according to claim 1,
wherein a surface electrical resistance of the surface of the antibacterial layer is equal to or less than 10¹⁰ Ω/square.

26. The antibacterial sheet according to claim 1,
wherein the surface electrical resistance of the surface of the antibacterial layer is equal to or less than 10⁹ Ω/square.

27. The antibacterial sheet according to claim 1,
wherein the surface electrical resistance of the surface of the antibacterial layer is equal to or less than 10⁸ Ω/square.

28. The antibacterial sheet according to claim 1,
wherein a thickness of the antibacterial layer is equal to or less than 10 μm.

29. The antibacterial sheet according to claim 1,
wherein the thickness of the antibacterial layer is equal to or less than 3 μm.

30. The antibacterial sheet according to claim 1,
wherein the thickness of the antibacterial layer is equal to or less than 1 μm.

31. The antibacterial sheet according to claim 1,
wherein the support consists of any one of polyethylene terephthalate, triacetyl cellulose, and polycarbonate.

32. An antibacterial coat comprising:
a binder;
an antibacterial agent;
a surfactant; and
silica particles having a mean particle size of equal to or less than 100 nm,
wherein the binder is formed using a siloxane oligomer represented by the following Formula (1), 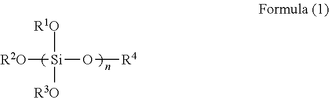
in Formula (1), R¹ to R⁴ each independently represent an organic group having 1 to 6 carbon atoms, and n represents an integer of 2 to 20.

33. The antibacterial coat according to claim 32,
wherein a water contact angle of materials remaining en the antibacterial agent is excluded from the antibacterial coat is equal to or less than 20°.

34. The antibacterial coat according to claim 32,
wherein the surfactant contains at least one kind of ionic surfactant.

35. The antibacterial coat according to claim 32,
wherein the surfactant contains at least one kind of nonionic surfactant.

36. The antibacterial coat according to claim 32, further comprising:
an antistatic agent.

37. The antibacterial coat according to claim 32,
wherein the antibacterial agent contains silver or silver-supporting ceramic.

38. The antibacterial coat according to claim 32,
wherein the antibacterial agent contains silver-supporting glass.

39. The antibacterial coat according to claim 32,
wherein an amount of silver ions, measured by the following extraction test, per unit area is equal to or greater than 15 ng/cm²,
in the extraction test, a 1/500 normal nutrient broth medium specified in JIS Z 2801:2010 is used as an extractant; the temperature of the extractant is controlled within a range of 35±1° C.; the extractant is brought into contact with a surface of the antibacterial coat for 1 hour; the amount of silver ions extracted into the extractant is measured; the obtained value is divided by a contact area between the surface of the antibacterial coat and the extractant so as to obtain the amount of silver ions per unit area; a unit of the amount of silver ions is ng; a unit of the contact area is cm²; and a unit of the amount of silver ions per unit area is ng/cm².

40. The antibacterial coat according to claim 32 that has a haze of equal to or less than 10%.

41. The antibacterial coat according to claim 32,
wherein the surface thereof has a root mean square roughness of equal to or less than 0.1 μm.

42. The antibacterial coat according to claim 32,
wherein the surface thereof has a surface electrical resistance of equal to or less than 10¹⁰ Ω/square.

43. The antibacterial coat according to claim 32 that has a film thickness of equal to or less than 10 μm.

44. A laminate obtained by laminating at least two layers of the antibacterial coat according to claim 32.

45. An antibacterial solution comprising:
a siloxane oligomer represented by the following Formula (1);
an antibacterial agent;
a surfactant; and
silica particles having a mean particle size of equal to or less than 100 nm, 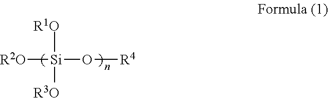
in Formula (1), R¹ to R⁴ each independently represent an organic group having 1 to 6 carbon atoms, and n represents an integer of 2 to 20.

46. The antibacterial solution according to claim 45,
wherein the surfactant contains an ionic surfactant.

47. The antibacterial solution according to claim 45, further comprising;
water,
wherein a content of water is equal to or greater than 40% by mass with respect to a total mass of the antibacterial solution.
